(19) United States
(12) Patent Application Publication
(10) Pub. No.: US 2026/0331036 A1
(43) Pub. Date: Oct. 22, 2026

(54) METHODS, DEVICES, AND SYSTEMS FOR 3D-INTEGRATED HETEROGENEOUS MICRODISPLAY SYSTEM ARCHITECTURE

(71) Applicant: Meta Platforms Technologies, LLC, Menlo Park, CA (US)

(72) Inventors: Huseyin Ekin Sumbul, San Francisco, CA (US); Brad Bartley, Denver, CO (US); Edith Dallard, San Mateo, CA (US); Johnny Tsung Lin Ho, Kirkland, WA (US); Pouya Houshmand, Menlo Park, CA (US); Matheus Trevisan Moreira, La Jolla, CA (US); William Anthony Smith, Seattle, WA (US); Fan Wu, San Jose, CA (US)

(21) Appl. No.: 19/647,847

(22) Filed: Apr. 14, 2026

Related U.S. Application Data
(60) Provisional application No. 63/792,231, filed on Apr. 21, 2025.

(51) Int. Cl. G09G 3/32

(52) U.S. Cl. CPC G09G 3/32; G09G 2300/026; G09G 2320/0247; G09G 2320/0276; G09G 2320/064; G09G 2330/023; G09G 2360/18

(57) ABSTRACT

A method of displaying images at an electronic device having a display including a pixel array and a plurality of compute tiles stacked with the pixel array. The method includes receiving image data corresponding to a frame to be displayed. The method further includes dividing the image data into a set of tile data corresponding to different portions of the pixel array. The method further includes concurrently processing, via the plurality of compute tiles, the set of tile data. Concurrently processing the set of tile data includes, for each tile data in the set of tile data, processing the tile data to generate processed tile data, and driving, based on the processed tile data, a corresponding subset of the pixel array.

### PRIORITY

This application claims priority to U.S. Provisional Application No. 63/792,231, titled “Methods, Devices, and Systems for 3D-Integrated Heterogeneous Microdisplay System Architecture”, filed Apr. 21, 2025, which is hereby incorporated by reference in its entirety.

### TECHNICAL FIELD

This relates generally to a three-dimensional display architecture, including but not limited to integrated heterogeneous microdisplay system architectures.

### BACKGROUND

Display backplane silicon is one of the challenging design points in optimizing display form factor, resolution, power consumption, and pixel performance. In particular, due to massive data communication between system-on-chip (SoC) and display, data movement accounts for a significant portion (e.g., approximately 90% in some systems) of the total power consumption in display pipelines operating at high frame rates.

As such, there is a need to address one or more of the above-identified challenges. A brief summary of solutions to the issues noted above are described below.

### SUMMARY

Various embodiments described herein relate to three-dimensional (3D) integration technologies for display systems, such as microdisplays used in augmented-reality glasses. A display system may include specialized layers stacked vertically: a digital chip (or compute die) at the bottom that handles pixel processing, an analog chip in the middle that drives the pixels, and a display chip at the top containing the pixel array. By stacking these layers vertically rather than arranging components side by side, periphery circuits and input/output logic can be relocated underneath the display, which can reduce bezel area and enable a more compact form factor. In some embodiments, a digital chip includes an array of compute tiles, where each compute tile is spatially proximate to and responsible for driving a corresponding portion of the pixel array. This localized pixel driving approach can reduce off-chip data movement between an external system-on-chip and the display, which can contribute to lower power consumption. In some embodiments, a tag-based pulse-width modulation mechanism is used to reduce redundant memory reads during pixel illumination, potentially achieving energy savings during pixel memory accesses. In some embodiments, a lightweight pixel-shifting architecture based on single-bit multiplexer arrays may enable the display to track real-time eye movements at subframe intervals without incurring the energy and latency costs of copying full pixel data between compute tiles. Together, these features can provide advantages in power efficiency, system performance, and compact form factor for integrated heterogeneous microdisplay system architectures.

In one aspect, a method of displaying images at an electronic device having a display including a pixel array and a plurality of compute tiles stacked with the pixel array is disclosed herein. The method includes receiving image data corresponding to a frame to be displayed. The method further includes dividing the image data into a set of tile data corresponding to different portions of the pixel array. The method further includes concurrently processing, via the plurality of compute tiles, the set of tile data. Concurrently processing the set of tile data includes, for each tile data in the set of tile data, processing the tile data to generate processed tile data, and driving, based on the processed tile data, a corresponding subset of the pixel array.

In another aspect, a circuit package for driving a display of an electronic device includes a digital chip, an analog chip vertically stacked over the digital chip, and a display chip vertically stacked over the analog chip and including a pixel array. The digital chip is electrically coupled to the analog chip via through-silicon vias and configured to drive the analog chip. The analog chip is heterogeneously integrated to the display chip through hybrid bonding and configured to drive the pixel array of the display chip.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A illustrates a comparison between 2D and 3D integrated graphics and display pipelines, in accordance with some embodiments.

FIG. 1B illustrates cross-sections of 2D integration and 3D integration for a display, in accordance with some embodiments.

FIG. 2 illustrates a high-level system overview of a 3D-stacked microdisplay system, in accordance with some embodiments.

FIG. 3 illustrates a top-level diagram of a digital die, in accordance with some embodiments.

FIG. 4 illustrates a compute tile block diagram, in accordance with some embodiments.

FIG. 5 illustrates a design-space exploration of tile static random-access memory (SRAM), in accordance with some embodiments.

FIG. 6A illustrates pulse-width modulation (PWM) operation for pixel rows, in accordance with some embodiments.

FIG. 6B illustrates tag-based PWM operation for pixel rows, in accordance with some embodiments.

FIG. 7 illustrates an overview of pixel-shifting mechanism, in accordance with some embodiments.

FIG. 8 illustrates a lightweight mux-array based single-bit pixel-shifting circuit in compute tiles, in accordance with some embodiments.

FIGS. 9A, 9B, 9C-1, and 9C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

In conventional display systems, a system-on-chip (SoC) handles graphics processing and sends image data to a separate display component over a high-bandwidth connection. This approach can result in significant power consumption because large amounts of pixel data must be transferred between the SoC and the display for every frame. Additionally, conventional displays typically include periphery circuits (such as analog pixel drivers and input/output logic) arranged around the edges of the pixel array, which contributes to larger bezel areas and overall device size.

The embodiments described herein address these challenges using 3D stacking approaches. In some embodiments, a display system includes three stacked layers: a digital chip (also referred to as a compute die) that handles pixel processing, an analog chip that drives the pixels, and a display chip containing the pixel array. The digital chip handles pixel processing tasks, the analog chip converts digital signals into analog driving signals for the pixels, and the display chip contains the actual light-emitting elements that form the visible image. The heterogeneous 3D-stacked architecture can enable selecting the best-suited transistor technology for each layer. In some embodiments, a cost-effective and area-effective technology may be used for the display die, such as technologies suitable for micro-LED or LCoS pixel arrays. In some embodiments, high-voltage transistors may be used for the analog die to support the voltage requirements of pixel driving. In some embodiments, a scaled technology node may be used for the digital die to enable high-performance processing and dense memory storage, such as dense SRAM for storing pixel values. By stacking these layers rather than arranging components side by side, periphery circuits and input/output logic can be relocated underneath the display, which may reduce bezel area and enable a more compact form factor suitable for applications such as augmented-reality glasses.

In some embodiments, the digital chip includes an array of compute tiles, where each compute tile is spatially aligned with and responsible for driving a corresponding portion of the pixel array above it. This localized approach means that pixel data can be stored and processed close to where it will be displayed, rather than being transmitted from a distant SoC for every frame. As a result, off-chip data movement between an external SoC and the display may be reduced, which can contribute to lower power consumption.

To further reduce energy consumption, some embodiments employ a tag-based pulse-width modulation (PWM) mechanism. In a typical PWM approach, pixel values are read from memory at every PWM counter increment to determine when to toggle pixel illumination. The tag-based approach instead first checks a smaller tag buffer to determine whether any pixels in a row need to change state at the current counter value. If no pixels need to change, the main memory read can be skipped entirely, potentially achieving substantial energy savings during pixel memory accesses.

Some embodiments also include a lightweight pixel-shifting architecture that enables the display to track real-time eye movements. In augmented-reality and virtual reality applications, a user's eyes may move rapidly between display refresh cycles. To reduce motion blur and improve perceived image quality, the display system may shift the displayed image position multiple times within a single frame period. Rather than copying full multi-bit pixel brightness values between compute tiles for each shift (which would be energy-intensive), the pixel-shifting architecture operates on single-bit ON/OFF states that indicate whether each pixel is illuminated at any given moment. This approach can enable energy-efficient positional pixel shifting without incurring the energy and latency costs of transferring full pixel data between tiles.

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional (3D) effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and/or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device); in other words, the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)) is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO2) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein, biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Display Pipelines

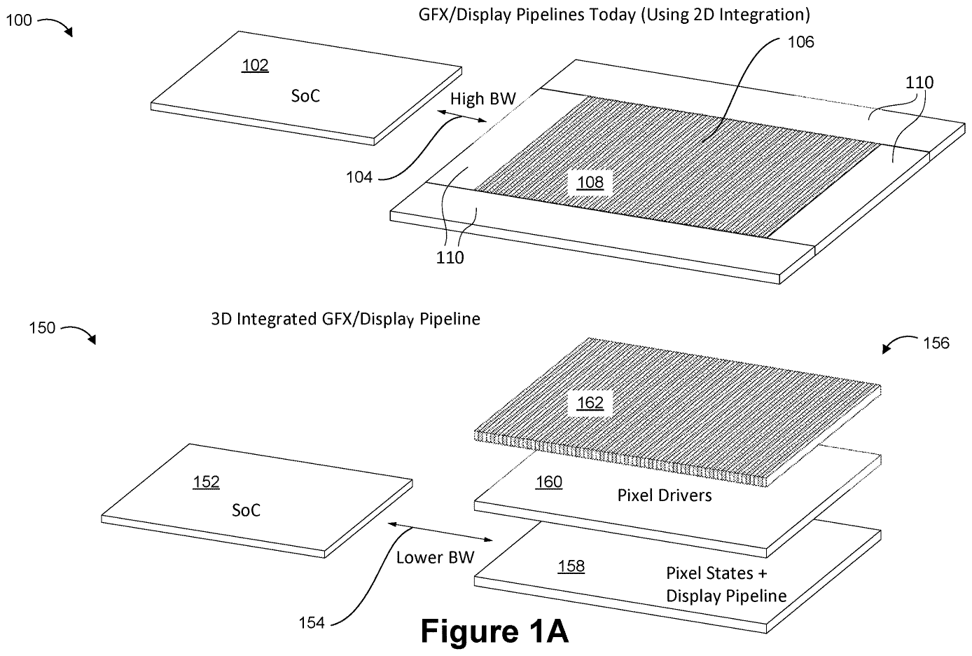

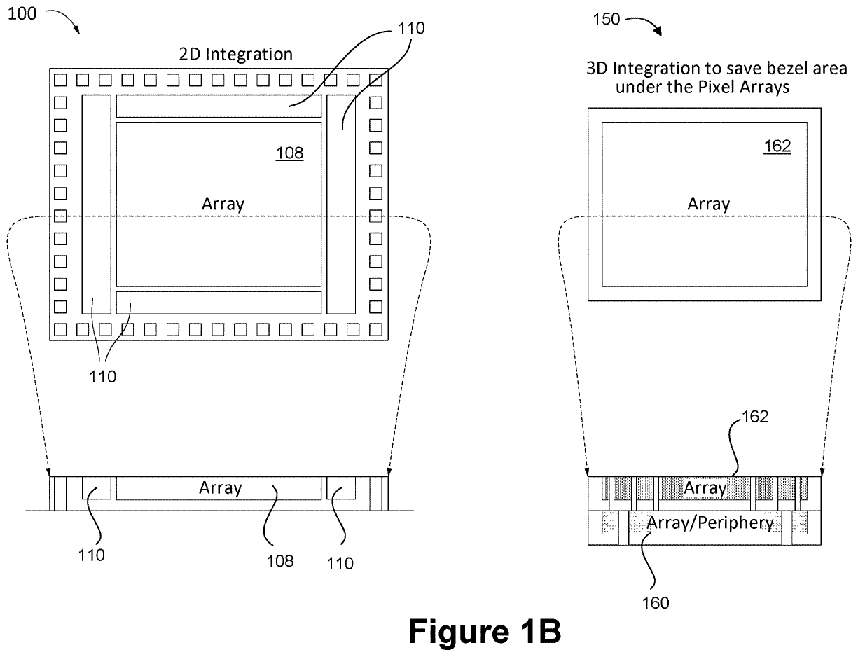

FIG. 1A illustrates a comparison between 2D and 3D integrated graphics and display pipelines, in accordance with some embodiments. The upper portion of FIG. 1A depicts a conventional 2D integration approach 100, while the lower portion depicts a 3D integrated graphics and display pipeline 150. In the 2D integration approach 100 shown in the upper portion of FIG. 1A, a SoC 102 with a graphics and display pipeline is connected via a high bandwidth connection 104 to a separate display component. The display component 106 includes a pixel array region 108 in the center, surrounded by periphery regions 110 on multiple sides. The periphery regions 110 house the analog pixel drivers and associated circuitry that control the pixel array region 108. In this conventional approach, a significant portion of the display footprint is occupied by the periphery regions 110 (e.g., periphery circuits) surrounding the pixel array (e.g., approximately 58% of the footprint).

In the 3D integrated graphics and display pipeline 150 shown in the lower portion of FIG. 1A, the 3D-stacked microdisplay system 156 comprises multiple vertically stacked layers. A SoC 152 with a graphics and display pipeline is connected via a lower bandwidth connection 154 to the 3D-stacked microdisplay system 156. The 3D-stacked microdisplay system 156 includes at least three layers arranged vertically. At the bottom is a first layer 158 containing pixel states and display pipeline functionality. In the middle is a layer containing pixel drivers 160 (e.g., analog drivers). At the top is the pixel array layer 162 representing the display pixels. The 3D-stacked microdisplay system 156 demonstrates how 3D integration technology enables relocating periphery and I/O logic underneath the display, thereby reducing the bezel area and achieving a more compact form factor compared to the conventional 2D integration approach. The lower bandwidth connection 154 between the SoC and the 3D-stacked display assembly indicates reduced off-chip data movement, which may contribute to lower power consumption in the display pipeline.

Although FIG. 1A illustrates a three-layer configuration, other embodiments may include additional layers. For example, a four-layer configuration may separate digital processing functions across two distinct digital layers, or may include a dedicated memory layer between the digital and analog layers. In some embodiments, the analog driver functionality and display pixel array are combined into a single layer, resulting in a two-layer configuration. The number and arrangement of layers can be selected based on manufacturing considerations, performance requirements, or form factor constraints for a particular application.

The connections between layers may be implemented using various interconnect technologies. In some embodiments, through-silicon vias (TSVs) provide electrical coupling between adjacent layers, enabling high-density vertical connections with relatively low parasitic capacitance. Hybrid bonding technology, which is a wafer-to-wafer bonding technology, may be used to achieve even higher interconnect densities between layers, particularly between the analog driver layer and the display layer. Other interconnect approaches, such as micro-bumps, copper pillars, or direct metal bonding, can also be used depending on the pitch requirements and manufacturing process compatibility. In some embodiments, different interconnect technologies are used between different pairs of layers within the same stack.

The functionality distributed across the layers may vary depending on the implementation. Although FIG. 1A depicts pixel states and display pipeline functionality in the first layer 158, other embodiments may distribute these functions differently. For example, certain display pipeline operations (such as gamma correction, scaling, or color space conversion) may be performed in the external SoC 152 rather than in the 3D-stacked assembly. In some embodiments, additional processing functions (such as image compression, decompression, or local dimming control) are incorporated into the digital layer. In some embodiments, calibration data storage and pixel compensation logic are included in the digital layer to support per-pixel brightness and color correction.

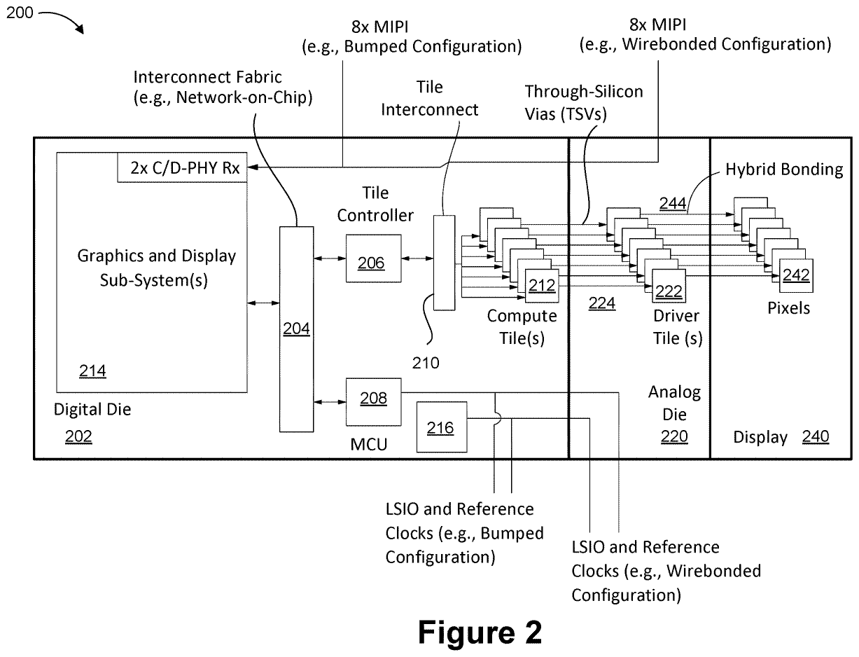

In some embodiments, the 3D integrated graphics and display pipeline 150 approach may reduce the periphery overhead (e.g., to approximately 14% of the footprint). Localizing the pixel driving to the digital and analog die 220, as shown in FIG. 2, may minimize off-chip interconnect and communication cost. For example, up to approximately 11% of system-level power consumption may be saved by minimizing off-chip interconnect traffic alone, and up to approximately 50% may be saved with additional architecture and circuit developments. The digital die 202, as shown in FIG. 2, on a scaled process node may offer opportunities to increase pixel depth (e.g., from 6-bit to 8-bit or higher) stored in dense SRAM memories, and achieve higher frame rates via high-performance specialized circuits (e.g., up to approximately a 2× increase). The analog die 220 may offer implementing stronger analog drivers with area-intensive features such as current-tuning and pixel measurement. In some embodiments, current-tuning may include circuitry configured to adjust drive current levels for individual pixels to compensate for variations in pixel characteristics, such as differences in light-emitting efficiency or threshold voltage across the pixel array. In some embodiments, pixel measurement may include sensing circuitry configured to measure pixel output characteristics, such as current flow or luminance levels, which may be used for calibration purposes to improve uniformity and accuracy of pixel illumination. Together with higher pixel depths and better pixel calibration storage in the digital die 202, these features may enable improving overall pixel performance. Functional disaggregation may offer offloading time-critical functions to the 3D-stacked microdisplay SoC to shorten the overall graphics-to-display primary path (e.g., cross-die traffic may be reduced by up to approximately 50%).

FIG. 1B illustrates cross-sections of 2D integration and 3D integration for a display in a 3D-stacked microdisplay system 156, in accordance with some embodiments. FIG. 1B further presents a comparison between a 2D integration approach and a 3D integration approach. In the 2D integration approach 100 depicted in FIG. 1B, a central array region representing the pixel array region 108 is surrounded by periphery regions 110 on multiple sides. In some embodiments, the periphery regions 110 include periphery circuits such as analog pixel drivers and associated input/output logic. A cross-sectional view of the 2D integration configuration shows the pixel array region 108 positioned on a substrate with the periphery regions 110 extending laterally beyond the array boundaries, contributing to a larger overall footprint.

FIG. 1B further illustrates the 3D integrated graphics and display pipeline 150 approach is depicted. In this configuration, the pixel array region 108 occupies a larger proportion of the visible surface area, with the periphery regions 110 relocated beneath the pixel array region 108 rather than surrounding it. The cross-sectional view of the 3D integrated graphics and display pipeline 150 illustrates a vertically stacked arrangement where the pixel array layer 162 is positioned above a combined array and periphery layer containing the pixel drivers 160. This stacked configuration demonstrates how the periphery and input/output logic can be placed underneath the display to achieve a smaller area and more compact form factor. In some embodiments, the 3D-stacked microdisplay system 156 utilizes this vertical integration approach to maximize pixel density on the display die by removing the periphery regions 110 to layers below the pixel array layer 162. In some embodiments, this architectural approach may enable a reduction in bezel area compared to the traditional 2D integration method where periphery regions 110 occupy substantial lateral space around the pixel array region 108.

Although FIG. 1B illustrates a specific cross-sectional arrangement with the pixel array layer 162 positioned above the pixel drivers 160, other layer arrangements are possible. In some embodiments, additional intermediate layers are included between the pixel array and the driver circuitry, such as color filter layers, light management layers, or additional routing layers. The relative thicknesses of the layers may vary depending on the manufacturing process and performance requirements. For example, the digital processing layer may be thinner than the analog driver layer in some implementations, while in other implementations the layers have similar thicknesses.

The types of periphery circuits that can be relocated underneath the display may include analog pixel drivers, digital control logic, input/output interfaces, power distribution networks, clock generation and distribution circuits, and data serialization and deserialization circuits. In some embodiments, only a subset of these periphery circuits is relocated underneath the display, while other circuits remain at the edges of the pixel array or are implemented in an external component. The selection of which circuits to relocate can be based on factors such as heat dissipation requirements, signal integrity considerations, or manufacturing yield optimization.

The pixel array technologies compatible with this vertical integration approach may include micro-LED arrays, liquid crystal on silicon (LCoS) arrays, organic light-emitting diode (OLED) arrays, and other emissive or reflective pixel technologies. In some embodiments, the pixel array includes sub-pixel arrangements for color display, such as RGB sub-pixels or RGBW sub-pixels. The pixel pitch and array dimensions can vary depending on the target application, ranging from high-density arrays for near-eye displays to lower-density arrays for other display applications.

The reduction in bezel area achievable through vertical integration may vary depending on the specific implementation. Factors that influence the bezel reduction include the size of the periphery circuits being relocated, the interconnect density achievable between layers, and any remaining edge circuits that cannot be relocated underneath the pixel array. In some embodiments, the bezel area is reduced by relocating substantially all periphery circuits underneath the display. In other embodiments, a partial reduction in bezel area is achieved by relocating only selected periphery circuits.

The compact form factor enabled by this vertical integration approach may be beneficial for various applications beyond augmented reality glasses. In some embodiments, the 3D-stacked display architecture is used in virtual reality headsets, smart glasses, head-up displays, camera viewfinders, medical imaging devices, or other applications where display size and weight are important considerations. The reduced bezel area can enable edge-to-edge display designs, tiled display configurations, or integration into space-constrained enclosures.

FIG. 2 illustrates a high-level system overview of a 3D-stacked microdisplay system 200, in accordance with some embodiments. The 3D-stacked microdisplay system 200 provides a detailed system overview of the 3D integrated graphics and display pipeline 150 introduced in FIG. 1A. The 3D-stacked microdisplay system 200 comprises a three-layer vertically stacked architecture including a digital die 202 at the bottom (e.g., a compute die housing compute tiles 212), an analog die 220 in the middle (e.g., analog pixel drivers), and a display die 240 at the top (e.g., pixel arrays).

The digital die 202, also referred to as the compute die or digital chip, houses one or more compute tiles 212 and includes several subsystems. The graphics and display subsystem 214 receives incoming display data from external sources (e.g., via C/D-PHY Rx 306 connections and MIPI 304 interfaces in bumped and wirebonded configurations) and processes the data for distribution to the compute tiles. The tile controller 206 manages the distribution of pixel data to the compute tiles, streaming data in a tile-row by tile-row fashion. The microcontroller (MCU) 208 with low-speed input/output (LSIO) functionality handles system-level control tasks such as bootup and housekeeping. The interconnect fabric 204 (e.g., a network-on-chip (NoC)) interconnects the subsystems and provides communication pathways within the digital die 202, enabling the compute tiles 212 to be integrated to the base subsystem. A crystal oscillator (XTAL) 216 with phase-locked loop (PLL) generates clock signals for synchronizing operations across the digital die 202. A tile interconnect 210 provides communication between the tile controller 206 on the digital die 202 and the driver tiles 222 on the analog die 220, enabling coordinated pixel driving across the stacked layers. In some embodiments, LSIO and reference clocks are provided through both bumped configuration on the digital die 202 and wirebonded configuration on the analog die 220.

The analog die 220 includes analog pixel drivers arranged in driver tiles 222. The analog die 220 is positioned between the digital die 202 and the display die 240. A tile interconnect 210 provides communication between the tile controller 206 on the digital die 202 and the driver tiles 222 on the analog die 220. In some embodiments, the tile interconnect 210 implements a 96-bit data bus for streaming data from the tile controller 206 to the compute tile rows, enabling efficient data transfer for the write path. The digital die 202 and analog die 220 are connected via through-silicon vias (TSVs) 224, which provide electrical coupling between the compute tiles 212 on the digital die 202 and the corresponding driver tiles 222 on the analog die 220. In some embodiments, the number and placement of TSVs 224 may be optimized to minimize their footprint while still achieving the necessary bandwidth for data transfer between the compute tiles 212 and the driver tiles 222. In some embodiments, grouping pixel arrays into pixel tiles allows for sharing common interfaces for bus, power, and clocking, which may save power and area. In some embodiments, the pixel-tiles on the analog die 220 may be floorplanned to maximize the utilized area for TSVs 224 and the analog drivers within the driver tiles 222. The analog die 220 and display die 240 are connected through hybrid bonding technology 244, which provides high-density interconnections between the driver tiles 222 and the pixel arrays 242. The display die 240 at the top of the stack contains the pixel arrays 242 that form the visible display surface.

The analog die 220 contains analog pixel drivers arranged in driver tiles 222, where each driver tile 222 is configured to convert digital pixel states received from a corresponding compute tile 212 into analog driving signals for controlling pixel illumination. The analog die 220 is positioned between the digital die 202 and the display die 240, serving as an intermediary layer that bridges the digital processing performed by the compute tiles 212 and the physical pixel actuation at the display die 240. A tile interconnect 210 provides communication between the tile controller 206 on the digital die 202 and the driver tiles 222 on the analog die 220, enabling the tile controller 206 to coordinate and synchronize pixel driving operations across the driver tiles 222. The digital die 202 and analog die 220 are connected via through-silicon vias (TSVs) 224, which provide electrical coupling between the compute tiles 212 on the digital die 202 and the corresponding driver tiles 222 on the analog die 220. Each compute tile 212 transmits pixel ON/OFF states through the TSVs 224 to its corresponding driver tile 222, which in turn converts these states into analog signals that control the timing and intensity of pixel illumination. The analog die 220 and display die 240 are connected through hybrid bonding technology 244, which provides high-density interconnections between the driver tiles 222 and the pixel arrays 242 on the display die 240. The display die 240 at the top of the stack contains the pixel arrays 242 that form the visible display surface, where the pixels in the pixel arrays 242 are driven by the analog signals generated by the driver tiles 222 in the analog die 220 below. In this manner, the compute tiles 212, driver tiles 222, and pixel arrays 242 cooperate across the three vertically stacked layers to achieve localized pixel driving, where digital and analog components are disaggregated across heterogeneous layers while maintaining spatial proximity to their corresponding pixel regions.

The localized pixel driving architecture of the 3D-stacked microdisplay system 200 enables various graphics and display processing functionalities to be implemented locally within the system. At the microarchitecture-level, the scaled process technology of the digital die 202 offers customizing the compute tiles 212 to locally perform operations such as reprojection, gamut binding, subframe updates, upscaling, foveation, and eye-movement-based pixel-shifting, where the results of these operations are transmitted through the TSVs 224 to the driver tiles 222 for driving the pixel arrays 242. At the system level, the digital die 202 may allow for offloading a part of the graphics pipeline from an external SoC as a functional block integrated into the digital die 202 via the interconnect fabric 204 (e.g., the NoC), thereby reducing off-chip bandwidth requirements and eliminating redundant latencies in the primary path for data packetization or compression and decompression. In some embodiments, architectural features of the 3D-stacked microdisplay system 200 include: pixel values stored locally in dense SRAMs within each compute tile 212 (e.g., 8-bit or higher bit-depth resolution), enabling the compute tiles 212 to independently manage pixel illumination for their corresponding driver tiles 222; a lightweight pixel shifting architecture based on single-bit mux-arrays that operates on the pixel ON/OFF states transmitted through the TSVs 224, enabling energy-efficient positional pixel shifting without incurring data copy and transfer energy and latency costs between compute tiles 212; an SRAM tagging based pixel value access mechanism that reduces redundant SRAM reads by first checking a tag buffer before accessing main SRAM, achieving substantial dynamic energy savings (e.g., more than 4×) during pixel memory accesses for PWM generation; and a lightweight tile interconnect 210 implementing a streaming architecture for tile-to-tile connections that streams data from the tile controller 206 to the compute tiles 212 in a pipelined fashion, eliminating the requirement for traffic control and data congestion. In some embodiments, the tile interconnect 210 implements a flattened butterfly topology that allows for hopping to farther away routers to minimize the latency penalty for physically distant tiles. In some embodiments, data passes at a single fast system clock cycle per router-to-router data passing. For example, with 44 tiles on a tile row and hops implemented to connect every 11 routers, the worst initial delay for the farthest tile to receive new data may be less than 14 clock cycles (e.g., 3 hops plus 11 neighbor transmissions). At an example 400 MHz system clock frequency, this corresponds to a worst initial delay of less than approximately 35 nanoseconds.

Although FIG. 2 illustrates a specific three-layer configuration with the digital die 202, analog die 220, and display die 240, other configurations are contemplated. In some embodiments, the digital die 202 includes additional functional blocks beyond those shown, such as dedicated image processing units, compression and decompression engines, or machine learning accelerators for display optimization. The interconnect fabric 204 may be implemented using various network-on-chip topologies, including mesh networks, ring networks, or hierarchical bus structures, depending on the bandwidth and latency requirements of the system.

The tile controller 206 and compute tiles 212 may be configured in various arrangements. In some embodiments, the number of compute tiles 212 differs from the arrangement shown in FIG. 2, with fewer or more tiles depending on the resolution of the display and the processing requirements. The tile sizes can vary, with larger tiles covering more pixels but requiring more local memory, or smaller tiles providing finer granularity but requiring more inter-tile communication. In some embodiments, the compute tiles 212 have non-uniform sizes, with tiles at the edges of the array being smaller than tiles in the center to accommodate irregular display shapes or to optimize for specific viewing regions.

The analog die 220 may include various types of driver circuits depending on the display technology. For micro-LED displays, the driver tiles 222 may include current-mode drivers with programmable current levels to control pixel brightness. For LCoS displays, the driver tiles 222 may include voltage-mode drivers that control the liquid crystal orientation. In some embodiments, the driver tiles 222 include calibration circuits for compensating pixel-to-pixel variations, aging effects, or temperature-dependent characteristics. The analog die 220 may also include power management circuits, reference voltage generators, or analog-to-digital converters for pixel sensing and feedback.

The display die 240 may support various pixel array configurations. In some embodiments, the pixel arrays 242 include monochrome pixels for applications where color is provided by external optics or sequential color illumination. Other embodiments include RGB pixel arrangements with separate red, green, and blue sub-pixels, or RGBW arrangements that add a white sub-pixel for improved efficiency. The pixel pitch can range from less than 5 micrometers for high-density near-eye displays to larger pitches for other applications. In some embodiments, the pixel arrays 242 include redundant pixels or repair mechanisms (e.g., to improve manufacturing yield).

The interconnect technologies between layers may vary. Although FIG. 2 depicts TSVs 224 between the digital die 202 and analog die 220, and hybrid bonding technology 244 between the analog die 220 and display die 240, other combinations are possible. In some embodiments, hybrid bonding is used between all adjacent layers to achieve the highest interconnect density. In other embodiments, TSVs are used throughout the stack for manufacturing simplicity. The pitch and density of the vertical interconnects can be selected based on the data bandwidth requirements between layers and the manufacturing process capabilities.

The MCU 208 and graphics and display subsystem 214 may be configured differently in various implementations. In some embodiments, the MCU 208 is a simple microcontroller for basic housekeeping tasks, while in other embodiments it includes more processing capability for runtime calibration, power management, or system diagnostics. The graphics and display subsystem 214 may support various input interfaces beyond MIPI, such as DisplayPort, HDMI, or proprietary high-speed serial interfaces. In some embodiments, the graphics and display subsystem 214 includes frame buffers, scaling engines, or color processing blocks that offload work from the external SoC.

The 3D-stacked microdisplay system 200 can be adapted for various applications. In some embodiments, the system is optimized for augmented reality glasses with emphasis on low power consumption and compact form factor. Other embodiments target virtual reality headsets where higher resolution and faster refresh rates may be prioritized. The architecture can also be applied to automotive head-up displays, medical imaging systems, industrial inspection equipment, or other applications requiring compact, high-performance displays. The modular nature of the stacked architecture allows different combinations of digital, analog, and display dies to be assembled for different application requirements.

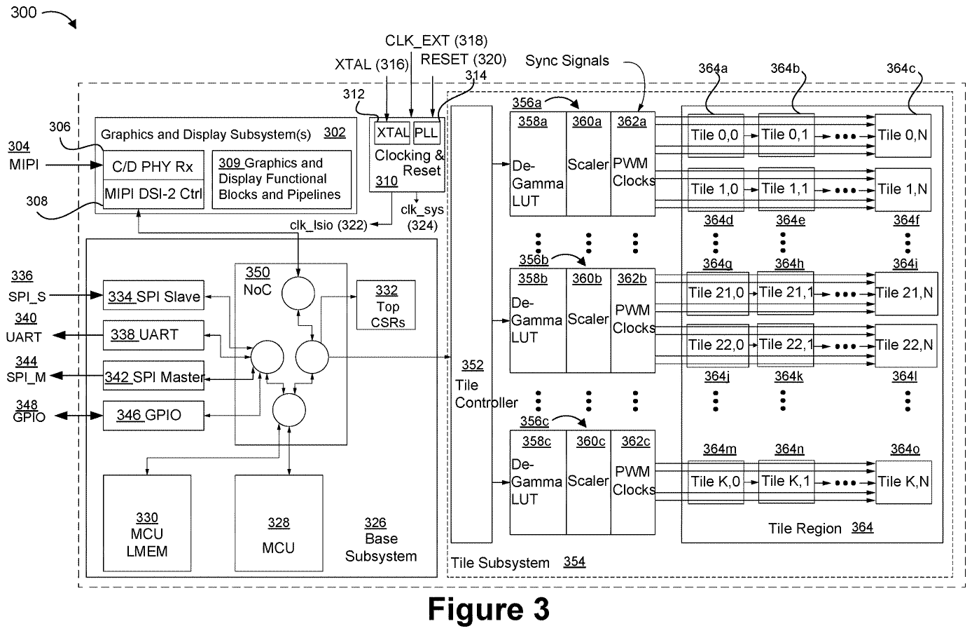

FIG. 3 illustrates a top-level diagram of a digital die 300, in accordance with some embodiments. The digital die 300 includes a graphics and display subsystem 302 positioned in an upper region. The graphics and display subsystem 302 receives input from external sources via an MIPI interface, which includes a C/D PHY Rx component 306 and an MIPI DSI-2 controller component 308. These interface components receive incoming display data (e.g., image frames from an external SoC) and pass the data to graphics and display functional blocks 309 and pipelines within the subsystem. The graphics and display functional blocks 309 process the incoming display data and prepare it for distribution to the compute tiles within the digital die 300. In this manner, the graphics and display subsystem serves as the entry point for image data into the digital die 300, bridging the external graphics pipeline with the internal tile-based processing architecture.

A clocking and reset block 310 is positioned adjacent to the graphics and display subsystem 302 and includes a crystal oscillator (XTAL) 312 component and a phase-locked loop (PLL) 314 component. The clocking and reset block 310 receives external signals including XTAL 316, CLK_EXT 318, and RESET 320, and generates clock signals (e.g., clk_lsio 322 and clk_sys 324) that are distributed throughout the digital die 300 to synchronize the operations of the various subsystems. The generated clock signals ensure that the base subsystem, the tile controller, and the compute tiles operate in a coordinated fashion.

The base subsystem 326 occupies a portion of the digital die 300 and encompasses a network-on-chip (NoC) that interconnects multiple components. The base subsystem 326 includes a microcontroller (MCU) 328 with associated MCU local memory (LMEM) 330, and top control and status registers (CSRs) 332. The MCU 328 handles system-level control tasks such as bootup and housekeeping operations. The base subsystem 326 further includes peripheral interfaces 334-338 comprising an SPI Slave 334 receiving SPI_S 336 input, a UART 338 receiving UART input 340, an SPI Master 342 providing SPI_M output 344, and GPIO 346 providing GPIO connectivity 348. These peripheral components connect to the NoC 350 through interconnect nodes, enabling the MCU 328 to communicate with and manage the peripheral interfaces 334-338. In some embodiments, the base subsystem 326 may be separated into two clock domains: a first region operating at a fast system clock domain (e.g., including the MCU 328, NoC 350, LMEM 330, and an SPI-to-AHB bridge controller that translates between the SPI interface and the internal bus) and a second region operating at a slower clock domain (e.g., including the UART 338, GPIO 346, a watchdog timer (WDT), and a base register file). The digital die 300 shown in FIG. 3 is vertically stacked beneath the analog die 220 described in reference to FIG. 2, with the compute tiles 364 in the tile subsystem 354 connecting to corresponding driver tiles 222 on the analog die 220 via TSVs 224. In some embodiments, input/output connections to off-chip ports may be routed through the digital die 300 using bumped configurations (e.g., solder bumps on the digital die 300 that connect directly to external components), and/or through the analog die 220 using wirebond configurations (e.g., wire connections from bond pads on the analog die 220 to external components), depending on the system use-cases.

A tile controller 352 is positioned between the base subsystem 326 and the tile subsystem 354. The tile controller 352 connects to the NoC 350 within the base subsystem 326 and manages the flow of pixel data from the graphics and display subsystem 302 to the compute tiles 364 (e.g., the tile region as illustrated in FIG. 3). The tile controller 352 is responsible for receiving pixel streams from the graphics and display subsystem 302 and dispatching the pixel data to the compute tiles 364, as well as synchronizing the illumination operations across the compute tiles 364. The tile controller 352 interfaces with multiple tile processing chains 356 (e.g., tile processing chains 356a-c as shown in FIG. 3), each tile processing chain 356 including a De-Gamma LUT 358 (e.g., De-Gamma LUTs 358a-c as shown in FIG. 3), a Scaler 360 (e.g., Scalers 360a-c as shown in FIG. 3), and PWM clocks 362 (e.g., PWM clocks 362a-c as shown in FIG. 3). The De-Gamma LUT 358 applies gamma correction to the incoming pixel data to generate gamma-corrected pixel data. The Scaler 360 resizes the gamma-corrected data to generate scaled pixel data before distributing it to the compute tiles 364. The tile interconnect 210 corresponds to the tile interconnect described in reference to FIG. 2; although the tile interconnect 210 is not explicitly depicted in FIG. 3, it represents the communication pathway through which the tile controller 352 distributes pixel data to the compute tiles 364 via the tile processing chains 356. In some embodiments, the tile controller 352 implements two main control mechanisms: a first mechanism for sending new pixel data to individual tile rows over the tile interconnect 210 with respect to pixel addresses, and a second mechanism for illumination in which gamma LUTs generate non-linear or linear PWM increments (e.g., referred to as “tickers”) that are globally sent to every compute tile 364 to initiate pixel driving. Sync signals are distributed from the tile controller 352 to the tile region for synchronizing illumination operations across the compute tiles 364. In some embodiments, the tile controller 352 can receive the pixel streams in pixel-row by pixel-row or in tile-by-tile fashion (e.g., when targeting μLED and LCoS displays, respectively). In some embodiments, a rolling shutter mechanism initiates pixel driving sequentially across rows, while a global shutter mechanism initiates pixel driving simultaneously across all rows, and either mechanism may be initiated by the tile controller 352.

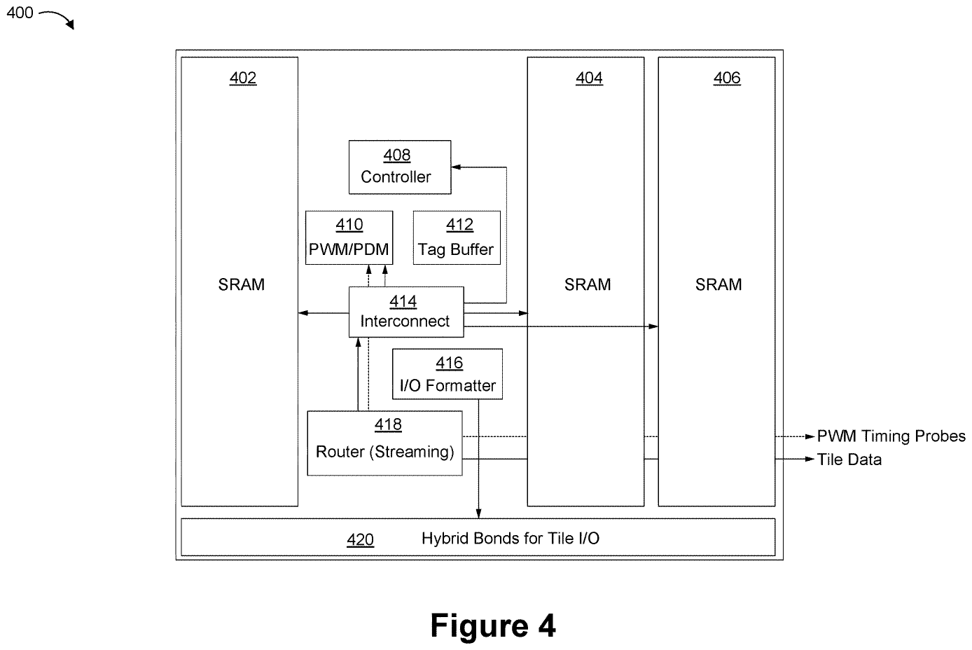

The tile subsystem 354, also referred to as the tile region, occupies a portion of the digital die 300 and contains a K by N array of identical, abutted compute tiles 364 arranged in rows and columns. The compute tiles 364 correspond to the compute tiles 212 described in reference to FIG. 2. Each compute tile 364 is responsible for the illumination of a corresponding group of pixels (e.g., an M×M pixel region) in the pixel array on the display die 240. Each compute tile 364 includes its own local controller and gamma look-up-tables (LUTs) for independently managing the illumination of its corresponding pixel region. In some embodiments, each compute tile 364 includes its own local controller, SRAM blocks, and PWM generation circuitry that operate independently of the other compute tiles 364. The tile controller 352 broadcasts global PWM timing signals (e.g., tickers) to all compute tiles 364 simultaneously, and upon receiving these timing signals, each compute tile 364 concurrently processes its locally stored pixel data and generates pixel ON/OFF states independently of the other compute tiles 364. In some embodiments, the values of K, N, and M may be selected to maximize the number of pixels on the display die and local pixel value storage (e.g., K and N may be 44 and M may be 64). Each row of compute tiles 364 receives PWM clock 362 signals from the tile controller 352 through the De-Gamma LUT 358 and Scaler 360 components. The compute tiles 364 within each row are connected in series, with data flowing from one tile to the next neighboring tile in a pipelined streaming fashion via the tile interconnect 210. The tile controller 352 streams pixel data to the compute tiles 364 on a tile-row by tile-row basis through the tile interconnect 210. Upon receiving the pixel data, each compute tile 364 processes the data locally and drives the corresponding pixel ON/OFF states through the TSVs 224 to the driver tiles 222 on the analog die 220, which in turn control the illumination of the pixel arrays 242 on the display die 240. The TSVs 224, driver tiles 222, analog die 220, display die 240, and pixel arrays 242 correspond to those described in reference to FIG. 2. The internal architecture of each compute tile 364 is described in further detail in reference to FIG. 4.

The digital die 300 is implemented as a flexible architecture that may integrate various additional functional blocks. The compute tiles 364 are connected to the NoC 350, which corresponds to the interconnect fabric 204 described in reference to FIG. 2. The NoC 350 enables communication between the compute tiles 364 and other subsystems within the digital die 300. Similarly, a functional block that is disaggregated from the main SoC graphics pipeline may also be integrated to the NoC 350 as part of the graphics and display subsystem 302. By integrating such functional blocks into the digital die 300, the architecture enables the system to reduce off-chip bandwidth requirements between the external SoC and the 3D-stacked microdisplay system, and to eliminate redundant latencies in the primary path that would otherwise be incurred by data packetization, compression, and decompression operations.

Although FIG. 3 illustrates a specific arrangement of subsystems within the digital die 300, other configurations are contemplated. In some embodiments, the graphics and display subsystem 302 supports input interfaces beyond MIPI, such as DisplayPort, HDMI, embedded DisplayPort (eDP), or proprietary high-speed serial interfaces. The graphics and display subsystem 302 may include additional processing blocks, such as image decompression engines, frame rate conversion logic, or display stream compression (DSC) decoders. In some embodiments, the graphics and display subsystem 302 includes multiple input channels to support stereoscopic display configurations or redundant data paths.

The base subsystem 326 may be configured differently in various implementations. In some embodiments, the MCU 328 is a simple microcontroller for basic bootup and housekeeping tasks, while in other embodiments the MCU 328 includes additional processing capability for runtime calibration, thermal management, or system diagnostics. The peripheral interfaces within the base subsystem 326 may vary, with different combinations of SPI, UART, I2C, GPIO, or other interface types depending on the system requirements. The NoC 350 may be implemented using various topologies, including mesh networks, ring networks, crossbar switches, or hierarchical bus structures, depending on the bandwidth and latency requirements of the system.

The tile controller 352 and tile subsystem 354 may be configured in various arrangements. In some embodiments, the number of compute tiles 364 differs from the K by N arrangement shown in FIG. 3, with fewer or more tiles depending on the resolution of the display and the processing requirements. The tile sizes can vary, with larger tiles covering more pixels but requiring more local memory, or smaller tiles providing finer granularity but requiring more inter-tile communication. In some embodiments, the tile processing chains 356 include additional processing stages beyond the De-Gamma LUT 358 and Scaler 360, such as dithering logic, local dimming control, or pixel compensation circuits. The number of tile processing chains 356 may differ from the three chains shown in FIG. 3, depending on the color configuration of the display (e.g., monochrome, RGB, RGBW).

The clocking and reset block 310 may support various clock configurations. In some embodiments, multiple PLLs are included to generate different clock frequencies for different subsystems within the digital die 300. The digital die 300 may operate with multiple clock domains, allowing different portions of the die to run at different frequencies to optimize power consumption. In some embodiments, the clocking and reset block 310 includes clock gating logic to disable clocks to inactive portions of the die, or dynamic frequency scaling to adjust clock speeds based on workload.

The tile interconnect 210 may be implemented using various topologies and routing schemes. Although FIG. 3 depicts a row-based streaming architecture where data flows from one tile to the next neighboring tile, other data distribution patterns are possible. In some embodiments, the tile interconnect 210 includes direct connections between non-adjacent tiles to reduce latency for certain data transfer patterns. The tile interconnect 210 may support bidirectional data flow to enable pixel shifting operations or inter-tile communication for image processing algorithms that require data from neighboring tiles. In some embodiments, the tile interconnect 210 includes separate data paths for pixel data and control signals to reduce contention and improve throughput.

The digital die 300 may support various additional processing functions beyond those shown in FIG. 3. In some embodiments, the digital die 300 includes dedicated hardware for foveated rendering, where pixel resolution varies across the display based on the user's gaze direction. The digital die 300 may include motion compensation logic to reduce motion blur, or local tone mapping circuits to optimize image quality for the display's dynamic range. In some embodiments, the digital die 300 includes test and debug circuitry, such as built-in self-test (BIST) logic or scan chains, to facilitate manufacturing testing and fault diagnosis.

FIG. 4 illustrates a compute tile block diagram, in accordance with some embodiments. As described in reference to FIGS. 2 and 3, the 3D-stacked microdisplay system 200 includes a digital die 202 that houses an array of compute tiles 400 responsible for locally processing and driving pixel illumination. The compute tile 400 represents a functional unit within the digital die 300 of the 3D-stacked microdisplay system 200, and corresponds to the compute tiles 212 described in reference to FIG. 2 and the compute tiles 364 described in reference to FIG. 3. Each compute tile 400 is responsible for managing the illumination of a corresponding group of pixels (e.g., an M×M pixel region) by storing pixel values locally, generating PWM signals to control pixel illumination timing, and transmitting pixel ON/OFF states to the analog die 220 for driving the display. The compute tile 400 includes three SRAM blocks (e.g., SRAM blocks 402, 404, and 406), each configured as a single-port, dense SRAM (e.g., 384×96 bits), arranged to store pixel values for a corresponding pixel region (e.g., a 64×64 pixel region). The SRAM blocks 402, 404, and 406 collectively implement a frame buffer for storing processed tile data, including pixel values for the corresponding pixel region managed by the compute tile 400. In some embodiments, the SRAM blocks 402, 404, and 406 may be configured with various bit configurations depending on the pixel region size and bit depth requirements. For example, a 384×96 bits configuration refers to a SRAM organized as 384 addressable rows, each 96 bits wide, providing a total storage capacity of 36,864 bits per SRAM blocks 402, 404, and 406, which is sufficient to store pixel values for a corresponding pixel region (e.g., a 64×64 pixel region) at the supported bit depths. The SRAM blocks 402, 404, and 406 have a native read/write width (e.g., 96 bits) that can be programmed for different bit depths (e.g., 6-bit, 8-bit, or 10/12-bit), allowing the compute tile 400 to support varying levels of pixel depth resolution. The SRAM blocks 402, 404, and 406 are positioned to maximize local pixel value storage capacity within the compute tile 400. In some embodiments targeting μLED displays, one SRAM block (e.g., SRAM block 402) stores calibration data while the other two SRAM blocks (e.g., SRAM blocks 404 and 406) store pixel data. Alternatively, the same architecture is also compatible with LCoS displays, where each SRAM block may store a respective color field (e.g., R, G, and B color fields). This local data storage approach allows for no-contention operation, as the reading (e.g., PWM generation) and writing (e.g., new frame data) from and to the SRAM blocks are staggered between operations. For example, one SRAM block may be in read mode while another SRAM block is in write mode, enabling simultaneous read and write operations without contention. In this manner, while one SRAM block stores incoming processed tile data as a frame buffer, another SRAM block may concurrently load its stored pixel values to the PWM/PDM block 410 for generating pixel ON/OFF states that drive the corresponding subset of the pixel array.

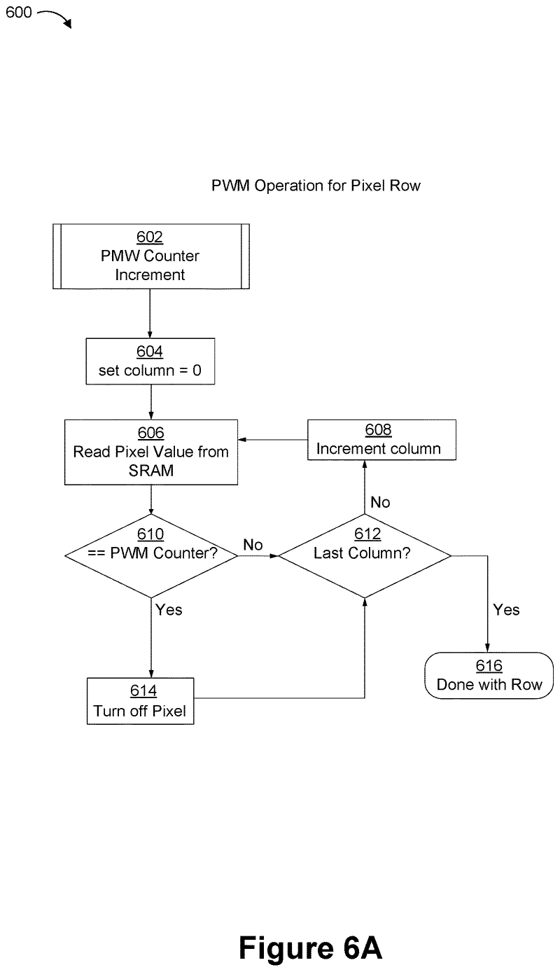

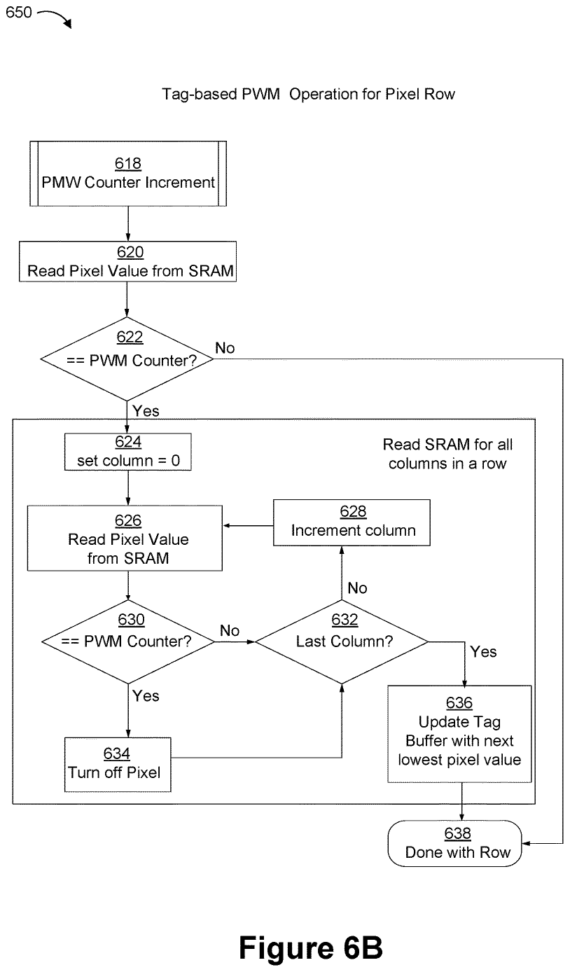

The compute tile 400 includes a controller 408 component that manages the overall operation of the tile. The controller 408 receives pixel streams from the tile controller (described in reference to FIG. 3) and coordinates the flow of data within the tile, directing incoming pixel data to the appropriate SRAM blocks 402, 404, and 406 for storage and initiating illumination operations when instructed by the tile controller. The controller 408 is operatively coupled to a Pulse Width Modulation (PWM)/Pulse Density Modulation (PDM) block 410, which receives pixel values read from the SRAM blocks 402, 404, and 406 and converts them into modulation signals that control pixel illumination timing. The PWM/PDM block 410 checks each pixel value against incoming ticks (e.g., PWM counter increments received from the tile controller) and generates single-bit ON/OFF signals that are ultimately driven through the TSVs 224 to the corresponding driver tiles 222. The TSVs 224 and driver tiles 222 correspond to those described in reference to FIG. 2. Adjacent to the PWM/PDM block 410 is a Tag Buffer 412 that implements the tag-based pixel value access mechanism. The Tag Buffer 412 stores the lowest pixel value in each row that is larger than the current PWM counter, allowing the PWM/PDM block 410 to first check the Tag Buffer 412 before accessing the main SRAM blocks. If the Tag Buffer 412 value does not match the current PWM counter, the SRAM read is skipped altogether, thereby reducing redundant SRAM reads and achieving substantial dynamic energy savings (e.g., more than 4×) during pixel memory accesses for PWM generation, as described in further detail in reference to FIGS. 6A and 6B.

The compute tile 400 includes an interconnect 414 positioned centrally within the tile that serves as a communication hub, facilitating data transfer between the controller 408, the SRAM blocks 402, 404, and 406, the PWM/PDM block 410, and the external tile interfaces. The interconnect 414 is coupled to an I/O Formatter 416 component, which manages the formatting and packetization of input and output data streams to ensure compatibility between the internal tile components and the external tile-to-tile communication pathways. The I/O Formatter 416 connects to a Router 418 component configured for streaming operation, which handles tile-to-tile data transmission in a pipelined fashion. The Router 418 receives PWM Timing Strobes and Tile Data from external sources on one side and outputs PWM Timing Strobes and Tile Data on the other side to neighboring tiles, enabling the streaming architecture for tile-row by tile-row data distribution as described in reference to FIG. 3. At the bottom of the compute tile 400, Hybrid Bonds for Tile I/O 420 provide the interface for vertical connections to the analog die 220 layer above. The analog die 220, TSVs 224, and driver tiles 222 correspond to those described in reference to FIG. 2. The Hybrid Bonds for Tile I/O 420 enable the compute tile 400 to transmit the single-bit ON/OFF pixel states generated by the PWM/PDM block 410 through the TSVs 224 to the corresponding analog pixel drivers in the driver tiles 222.

Although FIG. 4 illustrates a specific compute tile configuration with three SRAM blocks, other configurations are contemplated. In some embodiments, the compute tile 400 includes fewer than three SRAM blocks, such as a single SRAM block for simpler implementations or two SRAM blocks for dual-buffer operation. Other embodiments include more than three SRAM blocks to support higher bit depths, additional color channels, or separate storage for calibration data and pixel data. The size and organization of each SRAM block may vary, with different numbers of rows, different bit widths, or different access patterns depending on the pixel region size and performance requirements.

The bit depth supported by the SRAM blocks may vary across implementations. Although the description references 6-bit, 8-bit, and 10/12-bit configurations, other bit depths are possible. In some embodiments, the SRAM blocks support 4-bit or 5-bit pixel values for applications where lower color depth is acceptable. Other embodiments support 14-bit, 16-bit, or higher bit depths for applications requiring extended dynamic range or precise color reproduction. The SRAM blocks may be configured to store different bit depths for different color channels, such as higher bit depth for green pixels to match human visual sensitivity.

The controller 408 and PWM/PDM block 410 may be configured differently in various implementations. In some embodiments, the PWM/PDM block 410 supports only pulse-width modulation, while in other embodiments it supports only pulse-density modulation. The modulation scheme may be selectable at runtime to optimize for different display characteristics or power consumption targets. In some embodiments, the PWM/PDM block 410 includes multiple modulation engines operating in parallel to increase throughput or support different pixel groups simultaneously. The controller 408 may include programmable state machines, microcode engines, or hardwired control logic depending on the flexibility and performance requirements.

The Tag Buffer 412 may be implemented with various configurations. In some embodiments, the Tag Buffer 412 stores a single tag value per row, while in other embodiments it stores multiple tag values per row to enable finer-grained skipping of SRAM reads. The tag values may represent the minimum pixel value in a row, the maximum pixel value, or other statistical measures that enable efficient determination of whether SRAM access is needed. In some embodiments, the Tag Buffer 412 is omitted entirely, and the compute tile 400 reads pixel values from the SRAM blocks at every PWM counter increment. The size of the Tag Buffer 412 may vary depending on the number of rows in the pixel region and the bit depth of the tag values.

The Router 418 and interconnect 414 may support various data flow patterns and topologies. Although FIG. 4 depicts a streaming architecture where data flows from one tile to the next neighboring tile, other routing schemes are possible. In some embodiments, the Router 418 supports multi-hop routing to enable data transfer between non-adjacent tiles. The Router 418 may include buffering for flow control, priority arbitration for different data types, or quality-of-service mechanisms to ensure timely delivery of time-sensitive data. In some embodiments, the interconnect 414 includes separate buses or channels for different data types, such as pixel data, control signals, and synchronization signals.

The I/O Formatter 416 and Hybrid Bonds for Tile I/O 420 may be configured for different interconnect technologies and data formats. In some embodiments, the I/O Formatter 416 serializes parallel pixel data for transmission through the hybrid bonds, while in other embodiments it transmits data in parallel format. The number and arrangement of hybrid bonds may vary depending on the data bandwidth requirements and the pitch constraints of the bonding technology. In some embodiments, the Hybrid Bonds for Tile I/O 420 are replaced with through-silicon vias or other vertical interconnect technologies. The I/O Formatter 416 may include error detection or correction logic to improve data integrity across the vertical interconnects.

The compute tile 400 may support various additional processing functions beyond those shown in FIG. 4. In some embodiments, the compute tile 400 includes local image processing capabilities, such as spatial filtering, edge enhancement, or noise reduction. The compute tile 400 may include pixel compensation logic that adjusts pixel values based on calibration data to correct for pixel-to-pixel variations in brightness or color. In some embodiments, the compute tile 400 includes temperature sensing and compensation circuits to adjust pixel driving based on thermal conditions. The compute tile 400 may also include diagnostic circuitry for detecting and reporting pixel defects or other anomalies during operation.

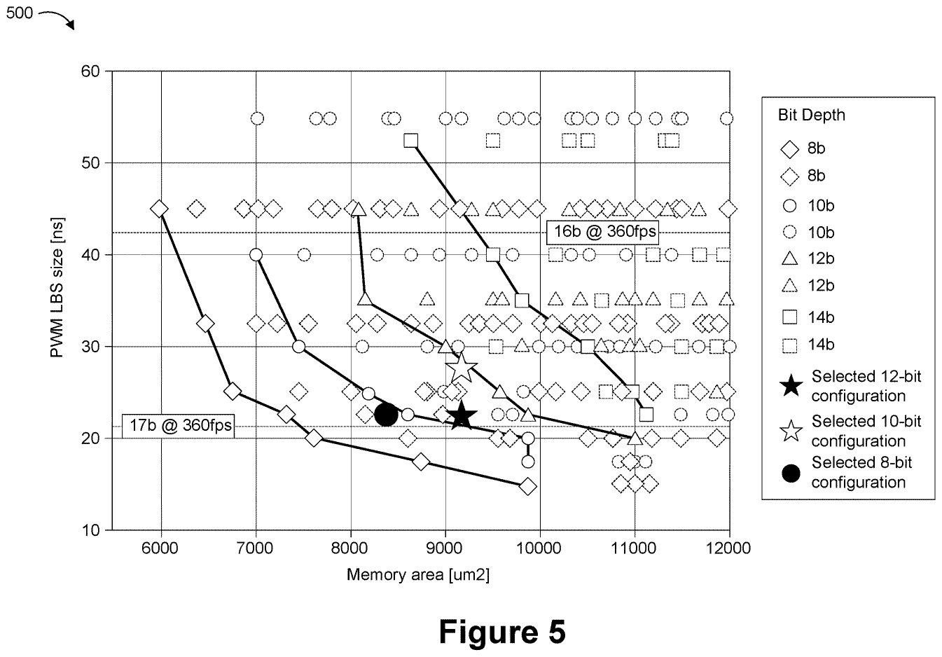

FIG. 5 illustrates a design-space exploration of tile static random-access memory (SRAM), in accordance with some embodiments. Design-space exploration is a process of evaluating many possible configurations to find the preferred options that balance competing requirements. The design-space exploration graph 500 plots PWM LSB (least significant bit) size in nanoseconds on the vertical axis against memory area in square micrometers on the horizontal axis. The PWM LSB size represents the finest timing resolution achievable for controlling pixel illumination. In simpler terms, it indicates how precisely the system can control when pixels turn on and off. A smaller PWM LSB size corresponds to finer control over pixel brightness levels. The memory area represents the silicon footprint allocated for the SRAM blocks within each compute tile 400, which directly impacts the overall form factor of the digital die 300. For example, this represents how much physical space the memory takes up on the chip.

The graph displays data points and trend lines for multiple bit depths, including 8-bit, 10-bit, 12-bit, and 14-bit configurations, with each bit depth represented by distinct lines with different shapes along the lines (e.g., 8-bit with the diamond shape, 10-bit in the circles, 12-bit in triangles, and 14-bit in the squares). Each trend line connects Pareto-efficient configurations for a given bit depth. Pareto-efficient configurations represent the preferred possible trade-offs where improving one parameter (e.g., timing precision) would require sacrificing another (e.g., memory area). For example, these are the more efficient design choices available. The trend lines show an inverse relationship between PWM LSB size and memory area: as memory area increases, the achievable PWM LSB size decreases (i.e., finer timing resolution), because larger SRAM blocks can store more pixel data and support more granular PWM operations. Simply put, dedicating more chip space to memory allows for more precise control of pixel brightness. Higher bit depths shift the trend lines to the right, indicating that higher bit depths require larger memory areas for a given PWM LSB size, as more bits per pixel require more storage capacity.

Two horizontal dashed lines indicate performance thresholds corresponding to target specifications for the display system. A first dashed line at approximately 43 nanoseconds corresponds to 16-bit PWM resolution at 360 frames per second, and a second dashed line at approximately 21.5 nanoseconds corresponds to 17-bit PWM resolution at 360 frames per second. These thresholds represent the PWM LSB sizes specified to achieve the respective PWM resolutions at the target frame rate, and configurations that fall below these lines meet or exceed the corresponding performance targets. Meeting these targets helps ensure smooth, flicker-free display performance at increased refresh rates, which is relevant for applications such as augmented reality where visual quality and responsiveness are paramount.

Several data points are highlighted with markers indicating selected design points within the exploration space. A filled circle marker on the 8-bit curve indicates a selected 8-bit configuration, an empty star marker on the 10-bit curve indicates a selected 10-bit configuration, and a filled star marker on the 12-bit curve indicates a selected 12-bit configuration. These highlighted design points represent the recommended configurations that balance the competing requirements of memory area, PWM timing precision, and bit depth resolution while meeting the target performance thresholds. In practical terms, these selected configurations represent the design choices that provide the preferred combination of image quality, chip size, and performance for the intended display applications. The background of the graph contains a grid of faded data points representing the broader design space that was evaluated during the exploration process, from which the Pareto-efficient configurations were derived.

The design-space exploration shown in FIG. 5 directly informs the SRAM configuration choices for the compute tiles 400 described in reference to FIG. 4, which in turn are part of the tile subsystem 354 described in reference to FIG. 3 and the digital die 202 described in reference to FIG. 2. In some embodiments, the SRAM configuration (e.g., 384×96 bits) described in reference to FIG. 4 was selected based on this design-space exploration, considering the trade-offs between target bandwidth, energy consumption, PWM parameters, and silicon area to maximize the stored pixel values for the corresponding pixel region (e.g., 64×64 pixels per tile) while achieving the target PWM performance for increased frame-rate operation. This careful balancing of design parameters helps ensure that the 3D-stacked microdisplay system 200 can deliver improved-quality images with precise brightness control while maintaining a compact form factor suitable for augmented-reality applications.

FIG. 6A illustrates a pulse-width modulation (PWM) operation method 600 for pixel rows, in accordance with some embodiments. The method 600 illustrates a typical PWM operation approach where pixel values stored in the SRAM blocks of the compute tile 400 are read and compared against a PWM counter to control pixel illumination. In some embodiments, a contributor to data movement energy within the compute tile 400 is reading the pixel data out of the SRAM blocks repeatedly to convert pixel values to PWM signals that control the pixel illumination time. In some embodiments, the method 600 includes incrementing a PWM counter value (602), which advances the counter to the next time step in the PWM cycle for comparing against stored pixel values. The method 600 further includes setting the column to zero (604), which initializes the column index to begin processing pixels from the start of the row. The method 600 further includes reading the pixel value from SRAM for the current column position (606), which retrieves the stored brightness value for the pixel being processed. The method 600 further includes determining whether the pixel value equals the PWM counter (610), which compares the retrieved pixel value against the current counter value to determine if the pixel is to change state. If the pixel value matches the PWM counter (Yes branch), the method 600 further includes turning off the pixel (614), which toggles the pixel state from on to off to control the pixel illumination duration via the PWM time-period. After turning off the pixel, or if the pixel value does not match the PWM counter (No branch), the method 600 further includes determining whether the current column is the last column in the row (612). If it is not the last column (No branch), the method 600 further includes incrementing the column (608), which advances to the next pixel position, and returning to read the pixel value from SRAM for the next column (606). If it is the last column (Yes branch), the method 600 proceeds to a “Done with Row” state (616), indicating that processing for the current row is complete and the method can return to increment the PWM counter for the next iteration. This approach involves reading all pixel values at every PWM counter increment to search for matches within the stored pixel values and consequently toggle the pixel state. The total number of PWM counter increments is 2^{L}, where L is the bit depth adopted to represent the pixel values in memory, and as such, 2^{L} reads of all pixel values may be performed. This can lead to a substantial number of SRAM reads (e.g., high dynamic power consumption) that result in relatively few PWM signal toggles, particularly when many pixel values in a row do not match the current PWM counter value.

Although FIG. 6A illustrates a specific PWM operation method with a particular sequence of steps, other approaches are contemplated. In some embodiments, the PWM counter increments linearly from zero to a maximum value determined by the bit depth (e.g., 0 to 255 for 8-bit pixel values). Other embodiments use non-linear counting schemes, such as logarithmic or gamma-corrected increments, to better match human visual perception of brightness levels. The PWM counter may count upward from zero, downward from a maximum value, or use a triangular counting pattern that alternates between counting up and counting down.

The comparison operation at step 610 may be implemented in various ways. Although FIG. 6A depicts checking whether the pixel value equals the PWM counter, other comparison operations are possible. In some embodiments, the comparison checks whether the pixel value is less than or equal to the PWM counter, which determines whether the pixel should be on or off at the current time step. The comparison logic may include hysteresis or debouncing to prevent rapid toggling of pixel states near threshold values. In some embodiments, multiple comparison thresholds are used to support multi-level pixel states or to implement dithering patterns.

The row and column processing order may vary across implementations. Although FIG. 6A depicts sequential processing of columns within a row, other traversal patterns are possible. In some embodiments, multiple columns are processed in parallel to increase throughput, with parallel comparison logic operating on multiple pixel values simultaneously. The processing order may follow a serpentine pattern (alternating left-to-right and right-to-left for successive rows) to reduce memory access latency. In some embodiments, pixels are processed in a block-based order rather than row-by-row to optimize for memory locality or to align with the tile-based architecture.

The pixel state transitions may be configured differently depending on the display technology and application requirements. Although FIG. 6A depicts turning off the pixel when the pixel value matches the PWM counter, other state transition schemes are possible. In some embodiments, pixels start in an off state and are turned on when the counter reaches the pixel value. The pixel may undergo multiple state transitions within a single frame period to implement pulse-density modulation or hybrid PWM/PDM schemes. In some embodiments, the pixel state transitions are staggered across different rows to reduce instantaneous current draw and minimize electromagnetic interference.

Alternative modulation schemes beyond PWM may be used in some implementations. Pulse-density modulation (PDM) distributes pixel on time across the frame period rather than concentrating it in a single continuous pulse, which can reduce flicker perception at lower brightness levels. Hybrid approaches may combine PWM for coarse brightness control with PDM for fine brightness adjustment. In some embodiments, the modulation scheme is selectable on a per-pixel basis or on a per-region basis to optimize for different content characteristics within the same frame.

The method 600 can be adapted for different display technologies. For micro-LED displays, the PWM signal controls the duration of current flow through each LED element. For LCoS displays, the PWM signal controls the duration of voltage application to each liquid crystal cell. For OLED displays, the PWM signal may be combined with current-level control to achieve the desired brightness while managing pixel aging. The timing parameters of the PWM operation (such as the PWM period and the minimum pulse width) may be adjusted based on the response characteristics of the particular display technology.

FIG. 6B illustrates a tag-based pulse-width modulation (PWM) method 650, in accordance with some embodiments. The method 650 addresses the redundant SRAM reads described in reference to FIG. 6A by implementing a two-step access mechanism using the Tag Buffer 412 described in reference to FIG. 4.

In some embodiments, the method 650 includes incrementing a PWM counter value (618), which advances the counter to the next time step in the PWM cycle. Rather than immediately reading all pixel values from SRAM as in the method 600 of FIG. 6A, the method 650 further includes reading a pixel value from the tag buffer (620), which retrieves the lowest pixel value in each row that is larger than the current PWM counter. The method 650 further includes determining whether the value read from the tag buffer equals the PWM counter (622), which checks if any pixel in the row is to be toggled at the current counter value. If the value does not match the PWM counter (No branch), which in many realistic cases it will not, the method 650 proceeds directly to a Done with Row state (638), indicating that processing for the current row is complete without requiring any SRAM access. This approach may provide an efficiency improvement: by checking the tag buffer first, the method 650 avoids accessing the main SRAM blocks altogether when no pixels in the row are to be toggled at the current PWM counter value.

If the tag buffer value matches the PWM counter (Yes branch), the method 650 further includes entering a loop to read SRAM for all columns in the row (624). Within this loop, the method 650 further includes setting the column to zero (626), which initializes the column index to begin processing pixels from the start of the row. The method 650 further includes reading the pixel value from SRAM for the current column (628), which retrieves the stored brightness value for the pixel being processed. The method 650 further includes determining whether the pixel value equals the PWM counter (630), which compares the retrieved pixel value against the current counter value to determine if the pixel is to change state. If the pixel value equals the PWM counter (Yes branch), the method 650 further includes turning off the pixel (634), which toggles the pixel state from on to off. If the pixel value does not equal the PWM counter (No branch), the method 650 bypasses the turn off step. The method 650 further includes determining whether the current column is the last column (632). If it is not the last column (No branch), the method 650 increments the column and returns to read the next pixel value from SRAM (628). If it is the last column (Yes branch), the method 650 further includes updating the tag buffer (636) with the next lowest pixel value that is larger than the current PWM counter, which prepares the tag buffer for the next PWM counter increment. The method 650 then proceeds to the Done with Row state (638).

By adopting the tag-based PWM method 650, the maximum number of reads from memory may be reduced by at least a factor T in the worst case scenario, where T=2^{L}/display\_dim (e.g., for a display dimension of 64 pixels and L=8 bits, this gives approximately 4× power savings). The worst case scenario represents a situation in which all pixel values within a row have different values. In realistic scenarios, the savings may be higher due to the probable presence of repeated pixel values within a row (e.g., an image will have spatial pixel commonality). In some embodiments, for a pixel tile (e.g., 64×64 pixels), the contribution of read power may be reduced in the worst case by approximately 4× and in the best case by approximately 64×.

Although FIG. 6B illustrates a specific tag-based PWM method with a particular sequence of steps, other approaches to reducing redundant memory accesses are contemplated. In some embodiments, the tag buffer stores different types of tag values depending on the implementation requirements. For example, the tag buffer may store the minimum pixel value in each row, the maximum pixel value, or a bitmap indicating which PWM counter values have at least one matching pixel in the row. The choice of tag representation can affect the granularity of SRAM access skipping and the size of the tag buffer.

The tag buffer checking mechanism may be implemented in various ways. In some embodiments, the tag buffer is checked once per row at each PWM counter increment, as shown in FIG. 6B. Other embodiments check the tag buffer at different granularities, such as once per group of rows or once per tile. The comparison operation at step 622 may use different logic depending on the tag representation, such as equality comparison for minimum-value tags or bit lookup for bitmap-based tags. In some embodiments, multiple tag buffers are maintained in parallel to support different access patterns or to enable pipelining of tag checks and SRAM accesses.

The SRAM access pattern when the tag matches may vary across implementations. Although FIG. 6B depicts reading all columns in the row when the tag matches, other access patterns are possible. In some embodiments, only a subset of columns is read based on additional tag information that indicates which columns contain matching pixel values. The SRAM access may be performed in bursts or in a pipelined fashion to reduce access latency. In some embodiments, the SRAM read width is configurable to balance between access granularity and energy consumption.

The tag buffer update mechanism at step 636 may be implemented differently in various embodiments. In some embodiments, the tag buffer is updated incrementally after each SRAM access by scanning the read pixel values to find the next lowest value larger than the current PWM counter. Other embodiments recalculate the tag values periodically or at the beginning of each frame. The tag update may be performed in parallel with other operations to hide the update latency. In some embodiments, the tag buffer is precomputed during the frame data loading phase and stored alongside the pixel data in the SRAM blocks.

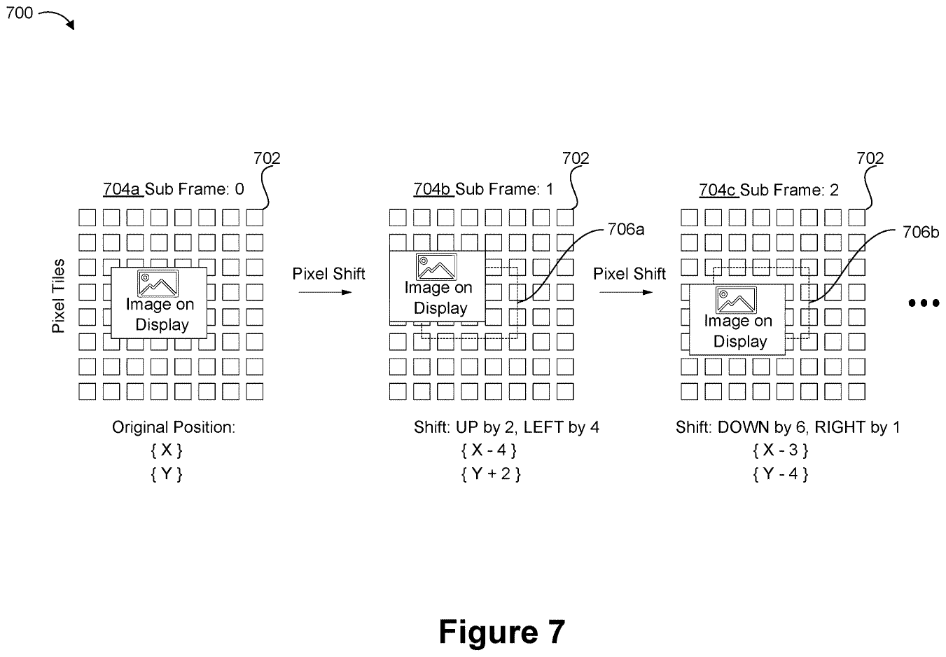

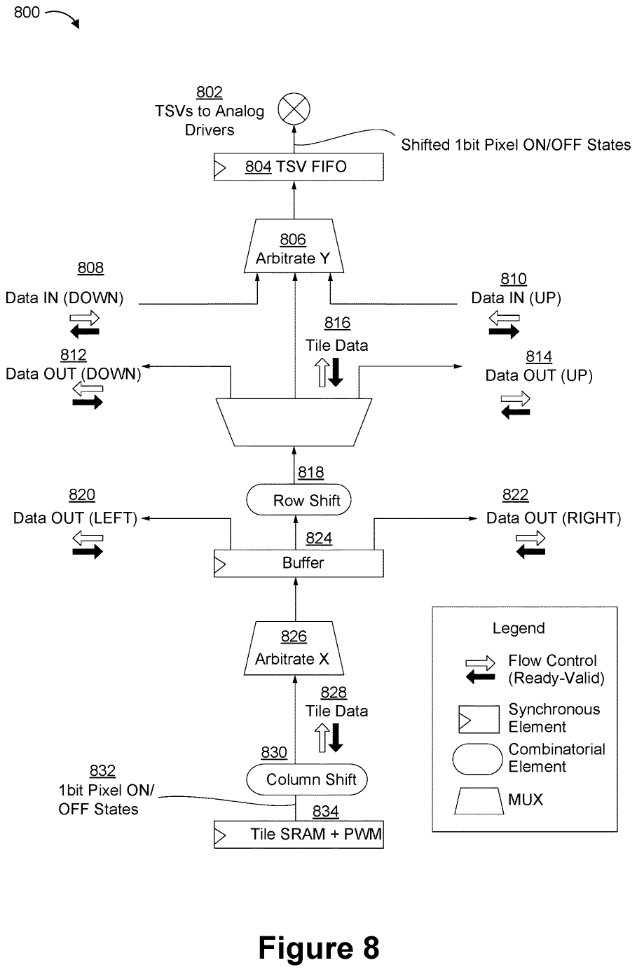

The tag-based approach can be combined with other energy-saving techniques. In some embodiments, clock gating is applied to the SRAM blocks when the tag buffer indicates that no access is needed, further reducing dynamic power consumption. The tag-based approach may be combined with data compression techniques that reduce the amount of data stored in the SRAM blocks. In some embodiments, the tag-based PWM method is used in conjunction with the pixel-shifting mechanism described in reference to FIGS. 7 and 8, where the tag buffer is updated to reflect shifted pixel positions.

The tag-based PWM method can be adapted for different display configurations and pixel arrangements. In some embodiments, separate tag buffers are maintained for different color channels (e.g., red, green, and blue) to enable independent optimization of SRAM accesses for each channel. For displays with sub-pixel rendering, the tag buffer may track pixel values at the sub-pixel level rather than the full pixel level. The method can be applied to displays with varying pixel pitches, resolutions, and aspect ratios by adjusting the tag buffer size and organization accordingly.

FIG. 7 illustrates an overview of a pixel-shifting mechanism 700, in accordance with some embodiments. Matching the real-time random eye movements of a user at subframe intervals may allow for achieving a smoother overall display experience. The method to match the random subframe eye movements is referred to as pixel shifting. In a conventional approach, the full pixel arrays in the display are updated at every subframe with the shifted image positions, which may be challenging for achieving increased frame rates and costly in energy. Enabled by the localized pixel compute of the 3D-stacked microdisplay system 200, the pixel-shifting mechanism 700 implements a lightweight pixel shifting architecture based on single-bit mux-arrays to achieve energy-efficient positional pixel shifting without incurring pixel data copy and transfer energy and latency costs between compute tiles 212. The compute tiles 212 correspond to those described in reference to FIG. 2.

The pixel-shifting mechanism 700 depicts a sequence of sub-frames showing how an image displayed on a pixel tile grid can be shifted in position to match real-time eye movements of a user. In augmented-reality (AR) and virtual reality (VR) applications, a user's eyes move rapidly and unpredictably between display refresh cycles. To reduce motion blur and improve perceived image quality, the display system may shift the displayed image position multiple times within a single frame period, with each shifted position corresponding to a sub-frame. Multiple sub-frames 704 (e.g., Sub Frame 0 704a, Sub Frame 1 704b, Sub Frame 2 704c) together make up one complete display frame. The pixel-shifting mechanism 700 illustrates this process using a grid of pixel tiles, where each tile corresponds to a compute tile 364 in the tile subsystem 354. An image position indicator shows the location of the displayed image within the pixel tile grid, and shift direction indicators show the direction and magnitude of each pixel shift between sub-frames. Sub Frame 0 704 a shows an image on the display at an original position with coordinates X and Y within the pixel tile grid. Sub Frame 1 704b shows the same image after a pixel shift operation where the image has been shifted in one or more directions (e.g., up by 2 pixels and left by 4 pixels), resulting in new coordinates (e.g., X−4 and Y+2), with a dashed outline indicating the previous position from Sub Frame 0 704a. Sub Frame 2 704c shows a subsequent pixel shift where the image has been shifted in different directions relative to Sub Frame 1 704b (e.g., down by 6 pixels and right by 1 pixel), resulting in updated coordinates (e.g., X−3 and Y−4), again with a dashed outline indicating the prior position from Sub Frame 1 704b. Additional sub-frames with further pixel shifts may continue in the sequence as the user's eye position changes.

To enable the pixel shifting mechanism per sub-frame, the tile array sends pixel data in up (U), down (D), left (L), and right (R) directions within the array. The pixel-shifting mechanism 700 demonstrates how pixel data can be sent in these directions within the tile array to achieve energy-efficient positional pixel shifting. In some embodiments, rather than copying full multi-bit pixel data sets between compute tiles 212 at every sub-frame, which would be energy-intensive and slow, the pixel-shifting mechanism 700 instead operates on the single-bit ON/OFF states that are driven to the TSVs 224. Since each pixel just requires a single bit to indicate whether it is on or off at any given moment, shifting these single-bit states between neighboring tiles is substantially more efficient than transferring full pixel brightness values (e.g., 8-bit or higher). This approach avoids the high energy cost of copying multi-bit pixel data from tile to tile per sub-frame, enabling the display to track eye movements at high speed without excessive power consumption. The compute tiles 212 and TSVs 224 correspond to those described in reference to FIG. 2.

Although FIG. 7 illustrates a specific pixel-shifting sequence with particular shift directions and magnitudes, other configurations are contemplated. The shift directions shown (up, down, left, right) represent one example, and diagonal shifts can be achieved by combining horizontal and vertical shift components. In some embodiments, the shift magnitudes vary from those shown in FIG. 7, with smaller shifts (e.g., single-pixel increments) for fine-grained eye tracking or larger shifts for rapid eye movements. The maximum shift distance supported by the pixel-shifting mechanism can be configured based on the expected range of eye movements and the size of the pixel tiles.

The number of sub-frames per frame may vary depending on the application requirements and the display refresh rate. Although FIG. 7 depicts three sub-frames (Sub Frame 0 704a , Sub Frame 1 704b, Sub Frame 2 704c), other embodiments include fewer sub-frames (e.g., two sub-frames for simpler implementations) or more sub-frames (e.g., four, eight, or more sub-frames for higher temporal resolution). In some embodiments, the number of sub-frames is dynamically adjustable based on detected eye movement speed, with more sub-frames used during rapid eye movements and fewer sub-frames used when the eye is relatively stationary. The sub-frame timing can be uniform (equal intervals between sub-frames) or non-uniform (variable intervals based on predicted eye positions).

The shift values applied at each sub-frame may be determined using various approaches. In some embodiments, the shift values are derived from real-time eye tracking data provided by eye tracking sensors (such as infrared cameras or other gaze detection systems) integrated into the display system or head-mounted device. Other embodiments use predictive algorithms that estimate future eye positions based on historical eye movement patterns, head motion data, or content analysis. In some embodiments, fixed or predetermined shift patterns are used for applications where eye tracking is not available or not required, such as anti-aliasing or resolution enhancement applications. The shift values may also be provided by an external system-on-chip or computed locally within the digital die.

The timing of pixel shifts within each frame period can be configured in various ways. In some embodiments, pixel shifts occur at fixed intervals within the frame period, with each sub-frame having equal duration. Other embodiments use adaptive timing where the shift intervals are adjusted based on the detected or predicted eye movement velocity. The pixel shift operation itself can be synchronized with the PWM illumination cycle to minimize visual artifacts during the transition between sub-frames. In some embodiments, the pixel shift is performed during a blanking interval when pixels are not illuminated, while in other embodiments the shift occurs while pixels remain illuminated with appropriate transition handling.

The pixel-shifting mechanism can be combined with other display features to enhance overall system performance. In some embodiments, pixel shifting is used in conjunction with foveated rendering, where higher resolution is provided in the region of the display corresponding to the user's gaze direction. The pixel-shifting mechanism may also be combined with local dimming or high dynamic range (HDR) processing to improve image quality. In some embodiments, the pixel-shifting data path is shared with other tile-to-tile communication functions to reduce circuit area and power consumption.

The pixel-shifting mechanism can be applied to applications beyond eye movement tracking. In some embodiments, pixel shifting is used for spatial anti-aliasing, where the displayed image is shifted by sub-pixel amounts across multiple sub-frames to achieve effective resolution enhancement. Other embodiments use pixel shifting for motion blur reduction by shifting the image in the opposite direction of detected motion. In some embodiments, pixel shifting is used for display calibration or testing purposes, where known shift patterns are applied to verify pixel alignment and timing accuracy. The pixel-shifting architecture can also support image stabilization for head-mounted displays by compensating for small head movements between frame updates.

FIG. 8 illustrates a lightweight mux-array based single-bit pixel-shifting circuit 800 in compute tiles, in accordance with some embodiments. The pixel-shifting circuit 800 implements the pixel-shifting mechanism 700 described in reference to FIG. 7 by providing a lightweight shifting network for single-bit pixel driver values that operates on top of the existing tile interconnect 210. The tile interconnect 210 corresponds to the tile interconnect described in reference to FIG. 2. At a high level, the pixel-shifting circuit 800 enables the display system to shift the position of displayed images between sub-frames to track a user's eye movements, without the high energy cost of copying full pixel brightness data between neighboring compute tiles. Instead, the pixel-shifting circuit 800 operates just on single-bit ON/OFF states, which indicate whether each pixel is illuminated at any given moment. This design avoids the high area cost of an additional 2D mesh network for shifting in all directions. In some embodiments, each tile may drive both itself and its neighboring tiles in all directions (e.g., up to 8 neighboring tiles). This approach mitigates the high energy cost of copying pixel data from tile to tile per sub-frame.

At the bottom of the pixel-shifting circuit 800, a Tile SRAM+PWM 834 block stores pixel values and generates pulse-width modulation signals. The Tile SRAM+PWM 834 block corresponds to the SRAM blocks 402, 404, and 406 and the PWM/PDM block 410 described in reference to FIG. 4. The Tile SRAM+PWM 834 block outputs 1-bit Pixel ON/OFF States 832, which represent the single-bit driver values that indicate whether each pixel is to be illuminated or not at the current PWM time step. In some embodiments, rather than outputting full brightness values (e.g., 8-bit values), the Tile SRAM+PWM 834 block outputs a simple on or off signal for each pixel. These 1-bit Pixel ON/OFF States 832 are fed into a Column Shift 830 component, which performs horizontal shifting of the pixel data within the tile based on the shift values received for the current sub-frame. The Column Shift 830 component shifts the pixel data left or right by the specified number of pixels within the tile boundaries.

The column-shifted data then enters an Arbitrate X 826 component that handles horizontal arbitration for pixel shifting in the left and right directions. The Arbitrate X 826 component determines whether the tile is to use its own pixel data or receive shifted pixel data from a neighboring tile in the horizontal direction. The Arbitrate X 826 component receives Tile Data 828 from neighboring tiles via Data In (LEFT) and Data In (RIGHT) paths, and outputs data to neighboring tiles via Data OUT (LEFT) 820 and Data OUT (RIGHT) 822 paths. Since left and right shifts are mutually exclusive (i.e., left and right shifts cannot occur at the same sub-frame), just one single-bit arbitrator is used for horizontal arbitration.

The data path continues upward through a Buffer 824 element, which temporarily stores intermediate data between the horizontal and vertical shifting stages. A Row Shift 818 component is positioned above the Buffer 824 and performs vertical shifting of the pixel data within the tile, shifting the pixel data up or down by the specified number of pixels. The row-shifted data then enters an Arbitrate Y 806 component that handles vertical arbitration for pixel shifting in the up and down directions. The Arbitrate Y 806 component determines whether the tile is to use its own pixel data or receive shifted pixel data from a neighboring tile in the vertical direction. The Arbitrate Y 806 component receives Tile Data 816 from neighboring tiles via Data IN (DOWN) 808 and Data IN (UP) 810 paths, and outputs data to neighboring tiles via Data OUT (DOWN) 812 and Data OUT (UP) 814 paths. Similar to the horizontal arbitration, since up and down shifts are mutually exclusive, just one single-bit arbitrator is used for vertical arbitration.

To handle diagonal shifts (i.e., shifts that have both a horizontal and vertical component), the pixel-shifting circuit 800 decouples the horizontal and vertical shifts to be performed in two consecutive cycles in a pipelined fashion. The horizontal shift is performed first via the Arbitrate X 826 component, and the vertical shift is performed in the following cycle via the Arbitrate Y 806 component. A Ready-Valid based back-pressure mechanism, represented by bidirectional flow control arrows, coordinates data transfer between neighboring tiles to ensure that each tile may drive both itself and its neighboring tiles in all directions without data loss.

The shifted 1-bit Pixel ON/OFF States output from the Arbitrate Y 806 component are passed through a TSV FIFO 804 component, which buffers the shifted states before they are transmitted via TSVs to Analog Drivers 802 on the analog die 220 above. The analog die 220, tile interconnect 210, TSVs 224, and compute tiles 212 correspond to those described in reference to FIG. 2. Shift values are global and are received through the tile interconnect 210 at the beginning of every sub-frame (e.g., in less than approximately 10 nanoseconds), which are then used to configure the mux-arrays for the current sub-frame. In this manner, the pixel-shifting circuit 800 implements a lightweight shifting network that operates on single-bit pixel driver values as an add-on to the illumination path, automatically handling pixel shifting using just the single-bit ON/OFF states driven to the TSVs 224 without incurring pixel data copy and transfer energy and latency costs between compute tiles 212.

Although FIG. 8 illustrates a specific pixel-shifting circuit configuration with particular components and data paths, other configurations are contemplated. In some embodiments, the mux-array architecture uses different multiplexer configurations, such as wider multiplexers that can select from more than two inputs to support larger shift distances in a single cycle. The shifting network may be implemented with different levels of parallelism, with some embodiments processing multiple pixel rows or columns simultaneously to increase throughput. In some embodiments, the pixel-shifting circuit is integrated more tightly with the PWM generation logic rather than operating as a separate stage in the data path.

The arbitration mechanisms for horizontal and vertical shifting may be implemented in various ways. Although FIG. 8 depicts separate Arbitrate X 826 and Arbitrate Y 806 components for horizontal and vertical arbitration, other embodiments combine these functions into a single arbitration unit. The arbitration logic may support different priority schemes, such as giving priority to certain shift directions or to data from specific neighboring tiles. In some embodiments, the arbitration includes conflict resolution mechanisms for cases where multiple tiles attempt to drive the same output simultaneously. The Ready-Valid back-pressure mechanism shown in FIG. 8 represents one approach to flow control, and other embodiments use alternative handshaking protocols or credit-based flow control.

The data flow and buffering within the pixel-shifting circuit may vary across implementations. Although FIG. 8 depicts a Buffer 824 element between the horizontal and vertical shifting stages, other embodiments use different buffer sizes or omit intermediate buffering entirely for lower-latency operation. The TSV FIFO 804 may be configured with different depths depending on the timing requirements and the variability in data arrival from the shifting network. In some embodiments, additional buffering is included at the tile boundaries to accommodate timing differences between neighboring tiles. The buffer configurations can be selected to balance between latency, throughput, and circuit area.

The distribution of shift values to the pixel-shifting circuit may be implemented differently in various embodiments. Although the description indicates that shift values are received through the tile interconnect 210 at the beginning of every sub-frame, other timing arrangements are possible. In some embodiments, shift values are preloaded for multiple sub-frames to reduce communication overhead. The shift values may be distributed hierarchically, with a global shift value broadcast to all tiles and local adjustments applied at each tile. In some embodiments, different regions of the display receive different shift values to support non-uniform shifting patterns or to compensate for optical distortions in the display system.

The interconnect topology for tile-to-tile data transfer during pixel shifting may vary. Although FIG. 8 depicts connections to immediately adjacent tiles in the up, down, left, and right directions, other embodiments include connections to diagonally adjacent tiles or to tiles that are multiple positions away. In some embodiments, the shifting network supports wrap-around connections at the edges of the tile array, allowing pixels shifted off one edge to appear on the opposite edge. The data width of the tile-to-tile connections may vary, with some embodiments transferring single bits per pixel as shown in FIG. 8, while other embodiments transfer multiple bits per pixel to support additional pixel state information. In some embodiments, the shifting network is configurable at runtime to enable or disable connections to specific neighboring tiles.

The pixel-shifting circuit can be adapted for different display configurations and applications. In some embodiments, the shifting circuit supports different shift granularities, such as sub-pixel shifting for displays with sub-pixel rendering or multi-pixel shifting for coarser position adjustments. The circuit may be configured to operate at different speeds, with higher-speed operation for displays with faster refresh rates or more sub-frames per frame. In some embodiments, the pixel-shifting circuit includes bypass modes that allow data to pass through without shifting when pixel shifting is not needed, reducing power consumption during static image display. The pixel-shifting architecture can also be extended to support rotation or scaling operations in addition to translation, enabling more complex image transformations within the tile array.

The following paragraphs describe embodiments of a 3D-stacked microdisplay system in which a plurality of compute tiles locally process and drive pixel illumination across a vertically stacked display architecture. The embodiments further describe a circuit package comprising a digital chip, an analog chip, and a display chip arranged in a three-layer stack connected via through-silicon vias and hybrid bonding.
(A1) In accordance with some embodiments, a non-transitory computer-readable storage medium stores instructions that, when executed by control circuitry of an electronic device having a display comprising a pixel array (e.g., pixel arrays 242 as described in reference to FIG. 2) and a plurality of compute tiles (e.g., compute tiles 212 as described in reference to FIG. 2, compute tiles 364 as described in reference to FIG. 3, and compute tile 400 as described in reference to FIG. 4) stacked with the pixel array, cause the control circuitry to perform operations. The operations include receiving image data corresponding to a frame to be displayed. The operations further include dividing the image data into a set of tile data corresponding to different portions of the pixel array. The operations further include concurrently processing, via the plurality of compute tiles, the set of tile data, including for each tile data in the set of tile data, processing the tile data to generate processed tile data, and driving, based on the processed tile data, a corresponding subset of the pixel array. For example, FIG. 2 illustrates the 3D-stacked microdisplay system 200 in which the digital die 202 houses compute tiles 212 that process pixel data locally and drive corresponding pixel states through the TSVs 224 to the driver tiles 222 on the analog die 220, which in turn control the illumination of the pixel arrays 242 on the display die 240. As described in reference to FIG. 3, the tile controller 352 receives pixel streams from the graphics and display subsystem 302 and distributes the image data to the compute tiles 364 on a tile-row by tile-row basis through the tile interconnect 210. Each compute tile 364 processes the tile data locally and drives the corresponding pixel ON/OFF states to the display.
(A2) In some embodiments of A1, processing the tile data to generate the processed tile data comprises generating gamma-corrected tile data by applying a gamma correction to the tile data, generating scaled tile data by resizing the gamma-corrected tile data, and generating the processed tile data by converting the scaled tile data to a pulse-width modulation (PWM) signal. For example, as described in reference to FIG. 3, the tile controller 352 interfaces with tile processing chains 356 that include a De-Gamma LUT 358 for applying gamma correction to the incoming pixel data to generate gamma-corrected pixel data, and a Scaler 360 for resizing the gamma-corrected data to generate scaled pixel data before distributing it to the compute tiles 364. As described in reference to FIG. 4, the PWM/PDM block 410 within each compute tile 400 converts the pixel values into PWM signals that control pixel illumination timing.
(A3) In some embodiments of any of A1 or A2, driving, based on the processed tile data, the corresponding subset of the pixel array includes storing the processed tile data in a respective compute tile, of the plurality of compute tiles, as a respective frame buffer, and concurrently loading the respective frame buffer from the respective compute tile for driving the corresponding subset of the pixel array. For example, as described in reference to FIG. 4, the compute tile 400 includes SRAM blocks 402, 404, and 406 that store pixel values for a corresponding pixel region. The SRAM blocks collectively implement a frame buffer for storing processed tile data. The SRAM blocks enable no-contention operation where one SRAM block may be in read mode while another SRAM block is in write mode, enabling simultaneous read and write operations without contention.
(A4) In some embodiments of any of A1-A3, the respective compute tile is spatially proximate to the corresponding subset of the pixel array and configured to drive the corresponding subset of the pixel array through a corresponding analog driver. For example, as described in reference to FIG. 2, each compute tile 212 on the digital die 202 is vertically aligned with a corresponding driver tile 222 on the analog die 220, which in turn drives the corresponding pixel arrays 242 on the display die 240 through the hybrid bonding technology 244.
(A5) In some embodiments of any of A1-A4, each of the plurality of compute tiles corresponds to a distinct subset of the pixel array. For example, as described in reference to FIG. 3, the tile subsystem 354 contains a K by N array of compute tiles 364 arranged in rows and columns, where each compute tile 364 is responsible for the illumination of a corresponding group of pixels (e.g., an M×M pixel region) in the pixel array on the display die 240, as shown in FIG. 2.
(A6) In some embodiments of any of A1-A5, the display further includes an analog driver, where the analog driver is vertically stacked over the plurality of compute tiles, and the pixel array is vertically stacked over the analog driver. For example, as described in reference to FIG. 2, the 3D-stacked microdisplay system 200 comprises a three-layer vertically stacked architecture including the digital die 202 at the bottom housing the compute tiles 212, the analog die 220 in the middle containing the driver tiles 222, and the display die 240 at the top containing the pixel arrays 242.
(A7) In some embodiments of any of A1-A6, the plurality of compute tiles are electrically coupled to the analog driver via through-silicon vias (TSVs) and configured to drive the analog driver, and the analog driver is heterogeneously integrated to the plurality of compute tiles through hybrid bonding and configured to drive the pixel array. For example, as described in reference to FIG. 2, the digital die 202 and analog die 220 are connected via TSVs 224, and the analog die 220 and display die 240 are connected through hybrid bonding technology 244.
(B1) In accordance with some embodiments, a circuit package for driving a display of an electronic device includes a digital chip (e.g., digital die 202 as described in reference to FIG. 2, digital die 300 as described in reference to FIG. 3), an analog chip (e.g., analog die 220 as described in reference to FIG. 2) vertically stacked over the digital chip, and a display chip (e.g., display die 240 as described in reference to FIG. 2) vertically stacked over the analog chip and including a pixel array (e.g., pixel arrays 242 as described in reference to FIG. 2), where the digital chip is electrically coupled to the analog chip via through-silicon vias (TSVs) (e.g., TSVs 224 as described in reference to FIG. 2) and configured to drive the analog chip, and the analog chip is heterogeneously integrated to the display chip through hybrid bonding (e.g., hybrid bonding technology 244 as described in reference to FIG. 2) and configured to drive the pixel array of the display chip. For example, FIG. 2 illustrates the 3D-stacked microdisplay system 200 comprising the three-layer vertically stacked architecture where the digital die 202 is connected to the analog die 220 via TSVs 224, and the analog die 220 is connected to the display die 240 through hybrid bonding technology 244. As used herein, the terms “digital chip,” “digital die,” and “compute die” may be used interchangeably to refer to the same component, and the terms “analog chip” and “analog die” may be used interchangeably to refer to the same component.
(B2) In some embodiments of B1, the digital chip includes an array of compute tiles arranged in rows and columns, the analog chip includes a plurality of analog drivers where each of the plurality of analog drivers corresponds to a respective compute tile of the array of compute tiles, and each compute tile of the array of compute tiles is configured to drive a corresponding subset of the pixel array of the display chip through the corresponding analog driver, and is spatially proximate to the corresponding subset of pixels of the display. For example, as described in reference to FIG. 2, the digital die 202 houses compute tiles 212 that are connected via TSVs 224 to corresponding driver tiles 222 on the analog die 220, which drive the pixel arrays 242 on the display die 240. As described in reference to FIG. 3, the tile subsystem 354 contains a K by N array of compute tiles 364 arranged in rows and columns.
(B3) In some embodiments of any of B1 or B2, the digital chip includes a tile controller (e.g., tile controller 206 as described in reference to FIG. 2, tile controller 352 as described in reference to FIG. 3) that is electrically coupled to the array of compute tiles and configured to sequentially drive the array of compute tiles on a per tile-row basis. For example, as described in reference to FIG. 3, the tile controller 352 manages the flow of pixel data from the graphics and display subsystem 302 to the compute tiles 364, streaming data in a tile-row by tile-row fashion through the tile interconnect 210, as shown in FIG. 2.
(B4) In some embodiments of any of B1-B3, the digital chip includes a system-on-chip (SoC) electrically coupled to the tile controller and configured to communicate image data with the tile controller. For example, as described in reference to FIGS. 1A and 2, the SoC 152 is connected to the 3D-stacked microdisplay system 200 via a lower bandwidth connection 154, and the graphics and display subsystem 214 receives incoming display data from external sources and processes the data for distribution to the compute tiles.
(B5) In some embodiments of any of B1-B4, the digital chip includes a network-on-chip (NoC) (e.g., NoC 350 as described in reference to FIG. 3, interconnect fabric 204 as described in reference to FIG. 2) electrically coupled to the tile controller, the SoC configured to stream image data between the tile controller and the SoC. For example, as described in reference to FIG. 3, the NoC 350 enables communication between the compute tiles 364 and other subsystems within the digital die 300, and corresponds to the interconnect fabric 204 described in reference to FIG. 2.
(C1) In accordance with some embodiments, a method of displaying images at an electronic device having a display comprising a pixel array (e.g., pixel arrays 242 as described in reference to FIG. 2) and a plurality of compute tiles (e.g., compute tiles 212 as described in reference to FIG. 2, compute tiles 364 as described in reference to FIG. 3, and compute tile 400 as described in reference to FIG. 4) stacked with the pixel array includes receiving image data corresponding to a frame to be displayed. The method further includes dividing the image data into a set of tile data corresponding to different portions of the pixel array. The method further includes concurrently processing, via the plurality of compute tiles, the set of tile data, including for each tile data in the set of tile data, processing the tile data to generate processed tile data, and driving, based on the processed tile data, a corresponding subset of the pixel array. For example, FIG. 2 illustrates the 3D-stacked microdisplay system 200 in which the digital die 202 houses compute tiles 212 that process pixel data locally and drive corresponding pixel states through the TSVs 224 to the driver tiles 222 on the analog die 220, which in turn control the illumination of the pixel arrays 242 on the display die 240. As described in reference to FIG. 3, the tile controller 352 receives pixel streams from the graphics and display subsystem 302 and distributes the image data to the compute tiles 364 on a tile-row by tile-row basis through the tile interconnect 210, as described in FIG. 2. Each compute tile 364 processes the tile data locally and drives the corresponding pixel ON/OFF states to the display.

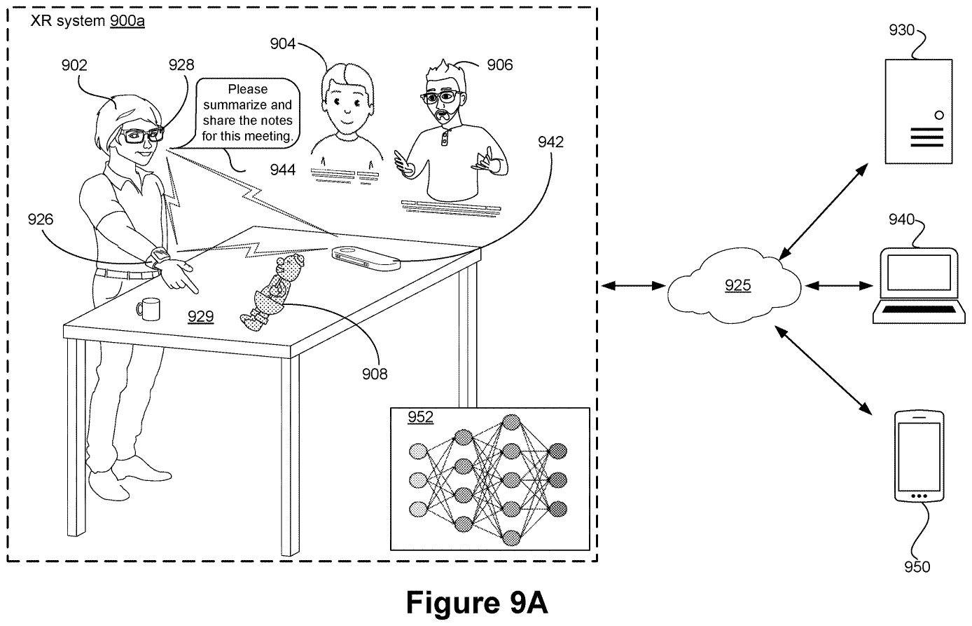

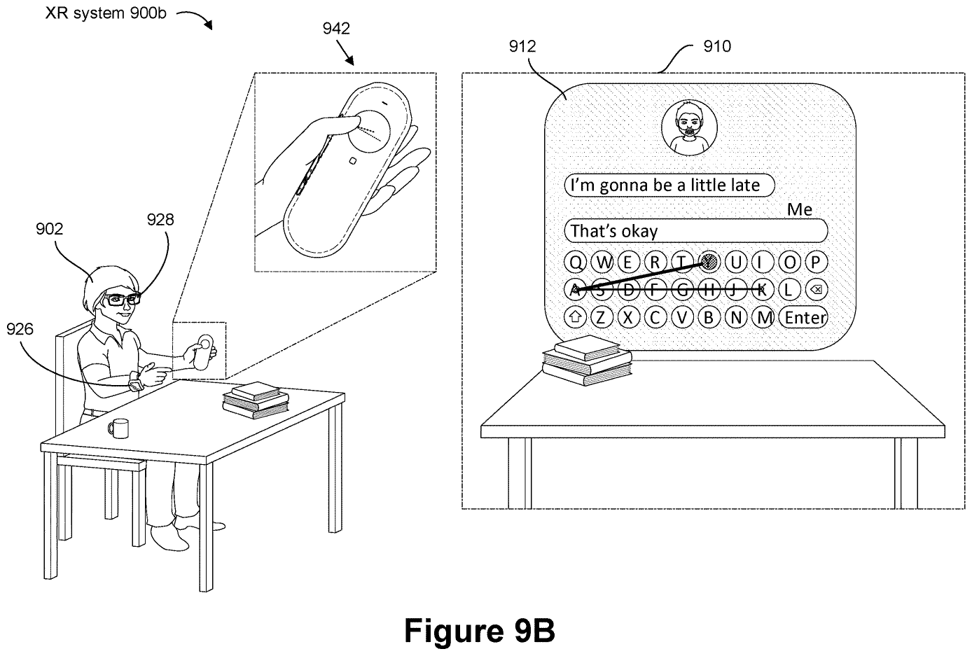

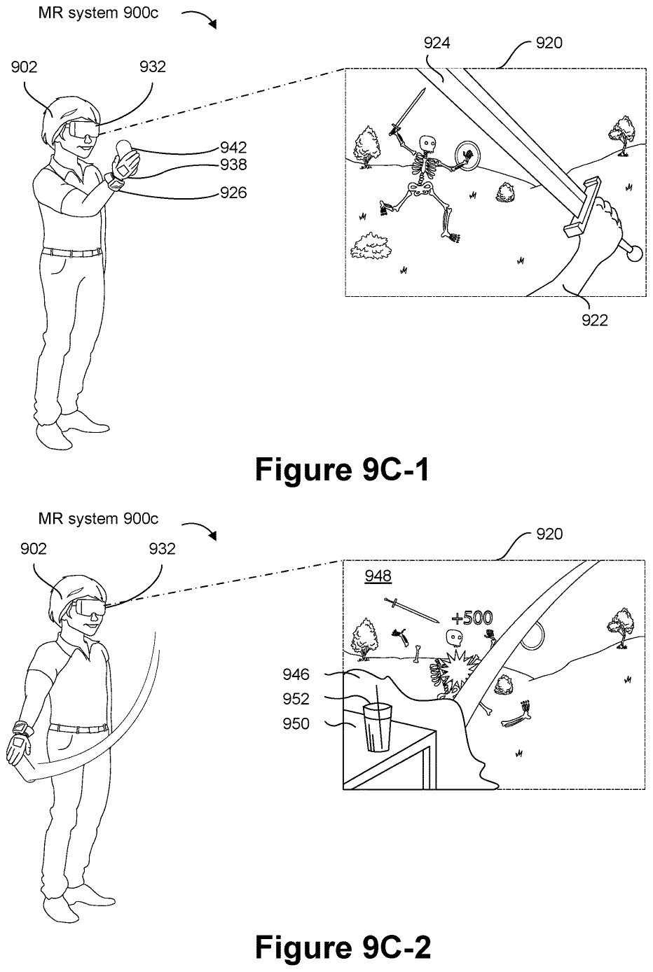

As used herein, control circuitry refers to electronic components or combinations of components configured to manage, coordinate, and direct the operation of other components within an electronic device or system. Control circuitry may include one or more controllers, processors, microcontrollers, tile controllers, or combinations thereof. For example, in a display system, control circuitry may include a tile controller configured to manage the distribution of pixel data to compute tiles (e.g., tile controller 206 as described in reference to FIG. 2, tile controller 352 as described in reference to FIG. 3), a microcontroller configured to handle system-level control tasks (e.g., MCU 208 as described in reference to FIG. 2, MCU 328 as described in reference to FIG. 3), and/or a controller within each compute tile configured to manage local tile operations (e.g., controller 408 as described in reference to FIG. 4). Control circuitry may be implemented using dedicated hardware, programmable logic, firmware, software executed by a processor, or combinations thereof. In some embodiments, the control circuitry interfaces with the plurality of compute tiles to execute operations by receiving image data corresponding to a frame through the graphics and display subsystem, dividing the image data into tile data through the tile controller, and distributing the tile data to the compute tiles via the tile interconnect. The control circuitry may coordinate concurrent processing of the tile data by the compute tiles, where each compute tile processes its respective tile data locally using its controller and stores the processed tile data in its SRAM blocks. The control circuitry may further coordinate driving of the pixel array by causing each compute tile to generate PWM signals based on the processed tile data and transmit pixel ON/OFF states through the TSVs to the corresponding driver tiles on the analog die. As used herein, the term “frame buffer” refers to memory configured to store pixel data for display, such as the SRAM blocks within compute tiles that store processed tile data including pixel values for corresponding pixel regions.
(C2) In some embodiments of C1, processing the tile data to generate the processed tile data comprises generating gamma-corrected tile data by applying a gamma correction to the tile data, generating scaled tile data by resizing the gamma-corrected tile data, and generating the processed tile data by converting the scaled tile data to a pulse-width modulation (PWM) signal. For example, as described in reference to FIG. 3, the tile controller 352 interfaces with tile processing chains 356 that include a De-Gamma LUT 358 for applying gamma correction to the incoming pixel data to generate gamma-corrected pixel data, and a Scaler 360 for resizing the gamma-corrected data to generate scaled pixel data before distributing it to the compute tiles 364. As described in reference to FIG. 4, the PWM/PDM block 410 within each compute tile 400 converts the pixel values into PWM signals that control pixel illumination timing.
(C3) In some embodiments of any of C1 or C2, driving, based on the processed tile data, the corresponding subset of the pixel array includes storing the processed tile data in a respective compute tile, of the plurality of compute tiles, as a respective frame buffer (e.g., SRAM blocks 402, 404, and 406 as described in reference to FIG. 4), and concurrently loading the respective frame buffer from the respective compute tile for driving the corresponding subset of the pixel array. For example, as described in reference to FIG. 4, the compute tile 400 includes SRAM blocks 402, 404, and 406 that store pixel values for a corresponding pixel region and collectively implement a frame buffer for storing processed tile data. The SRAM blocks enable no-contention operation where one SRAM block may be in read mode while another SRAM block is in write mode, enabling simultaneous read and write operations without contention.
(C4) In some embodiments of any of C1-C3, the respective compute tile is spatially proximate to the corresponding subset of the pixel array and configured to drive the corresponding subset of the pixel array through a corresponding analog driver. For example, as described in reference to FIG. 2, each compute tile 212 on the digital die 202 is vertically aligned with a corresponding driver tile 222 on the analog die 220, which in turn drives the corresponding pixel arrays 242 on the display die 240 through the hybrid bonding technology 244.
(C5) In some embodiments of any of C1-C4, each of the plurality of compute tiles corresponds to a distinct subset of the pixel array. For example, as described in reference to FIG. 3, the tile subsystem 354 contains a K by N array of compute tiles 364 arranged in rows and columns, where each compute tile 364 is responsible for the illumination of a corresponding group of pixels (e.g., an M×M pixel region) in the pixel array on the display die 240.
(C6) In some embodiments of any of C1-C5, the display further includes an analog driver, where the analog driver is vertically stacked over the plurality of compute tiles, and the pixel array is vertically stacked over the analog driver. For example, as described in reference to FIG. 2, the 3D-stacked microdisplay system 200 comprises a three-layer vertically stacked architecture including the digital die 202 at the bottom housing the compute tiles 212, the analog die 220 in the middle containing the driver tiles 222, and the display die 240 at the top containing the pixel arrays 242.
(C7) In some embodiments of any of C1-C6, the plurality of compute tiles are electrically coupled to the analog driver via through-silicon vias (TSVs) and configured to drive the analog driver, and the analog driver is heterogeneously integrated to the plurality of compute tiles through hybrid bonding and configured to drive the pixel array. For example, as described in reference to FIG. 2, the digital die 202 and analog die 220 are connected via TSVs 224, and the analog die 220 and display die 240 are connected through hybrid bonding technology 244.
(D1) In accordance with some embodiments, an electronic device includes a display comprising a pixel array (e.g., pixel arrays 242 as described in reference to FIG. 2) and a plurality of compute tiles (e.g., compute tiles 212 as described in reference to FIG. 2, compute tiles 364 as described in reference to FIG. 3, and compute tile 400 as described in reference to FIG. 4) stacked with the pixel array, and control circuitry configured to receive image data corresponding to a frame to be displayed, divide the image data into a set of tile data corresponding to different portions of the pixel array, and concurrently process, via the plurality of compute tiles, the set of tile data, including for each tile data in the set of tile data, process the tile data to generate processed tile data, and drive, based on the processed tile data, a corresponding subset of the pixel array. For example, FIG. 2 illustrates the 3D-stacked microdisplay system 200 in which the digital die 202 houses compute tiles 212 that process pixel data locally and drive corresponding pixel states through the TSVs 224 to the driver tiles 222 on the analog die 220, which in turn control the illumination of the pixel arrays 242 on the display die 240. As described in reference to FIG. 3, the tile controller 352 receives pixel streams from the graphics and display subsystem 302 and distributes the image data to the compute tiles 364 on a tile-row by tile-row basis through the tile interconnect 210.
(D2) In some embodiments of D1, the control circuitry is further configured to process the tile data to generate the processed tile data by generating gamma-corrected tile data by applying a gamma correction to the tile data, generating scaled tile data by resizing the gamma-corrected tile data, and generating the processed tile data by converting the scaled tile data to a pulse-width modulation (PWM) signal. For example, as described in reference to FIG. 3, the tile controller 352 interfaces with tile processing chains 356 that include a De-Gamma LUT 358 for applying gamma correction to the incoming pixel data to generate gamma-corrected pixel data, and a Scaler 360 for resizing the gamma-corrected data to generate scaled pixel data before distributing it to the compute tiles 364. As described in reference to FIG. 4, the PWM/PDM block 410 within each compute tile 400 converts the pixel values into PWM signals that control pixel illumination timing.
(D3) In some embodiments of any of D1 or D2, the control circuitry is further configured to drive, based on the processed tile data, the corresponding subset of the pixel array by storing the processed tile data in the respective compute tile as a respective frame buffer, and concurrently loading the respective frame buffer from the respective compute tile for driving the corresponding subset of the pixel array. For example, as described in reference to FIG. 4, the compute tile 400 includes SRAM blocks 402, 404, and 406 that store pixel values for a corresponding pixel region. The SRAM blocks enable no-contention operation where one SRAM block may be in read mode while another SRAM block is in write mode, enabling simultaneous read and write operations without contention.
(D4) In some embodiments of any of D1-D3, the respective compute tile is spatially proximate to the corresponding subset of the pixel array and configured to drive the corresponding subset of the pixel array through a corresponding analog driver. For example, as described in reference to FIG. 2, each compute tile 212 on the digital die 202 is vertically aligned with a corresponding driver tile 222 on the analog die 220, which in turn drives the corresponding pixel arrays 242 on the display die 240 through the hybrid bonding technology 244.
(D5) In some embodiments of any of D1-D4, each of the plurality of compute tiles corresponds to a distinct subset of the pixel array. For example, as described in reference to FIG. 3, the tile subsystem 354 contains a K by N array of compute tiles 364 arranged in rows and columns, where each compute tile 364 is responsible for the illumination of a corresponding group of pixels (e.g., an M×M pixel region) in the pixel array on the display die 240.
(D6) In some embodiments of any of D1-D5, the display further includes an analog driver, where the analog driver is vertically stacked over the plurality of compute tiles, and the pixel array is vertically stacked over the analog driver. For example, as described in reference to FIG. 2, the 3D-stacked microdisplay system 200 comprises a three-layer vertically stacked architecture including the digital die 202 at the bottom housing the compute tiles 212, the analog die 220 in the middle containing the driver tiles 222, and the display die 240 at the top containing the pixel arrays 242.
(E1) In accordance with some embodiments, a system that includes a wrist-wearable device (e.g., wrist-wearable device 926 as described in reference to FIGS. 9A-9C) (or a plurality of wrist-wearable devices) and a pair of augmented-reality glasses (e.g., AR device 928 as described in reference to FIG. 9A), and the system is configured to perform operations corresponding to any of A1-A7.

The devices described above are further detailed below, including wrist-wearable devices, headset devices, systems, and haptic feedback devices. Specific operations described above may occur as a result of specific hardware; such hardware is described in further detail below. The devices described below are not limiting and features on these devices can be removed or additional features can be added to these devices.

### Example Extended-Reality Systems

FIGS. 9A, 9B, 9C-1, and 9C-2 illustrate example XR systems that include AR and MR systems, in accordance with some embodiments. FIG. 9A shows a first XR system 900a and first example user interactions using a wrist-wearable device 926, a head-wearable device (e.g., AR device 928), and/or a HIPD 942. FIG. 9B shows a second XR system 900b and second example user interactions using a wrist-wearable device 926, AR device 928, and/or an HIPD 942. FIGS. 9C-1 and 9C-2 show a third MR system 900c and third example user interactions using a wrist-wearable device 926, a head-wearable device (e.g., an MR device 932 such as a VR device), and/or an HIPD 942. As the skilled artisan will appreciate upon reading the descriptions provided herein, the above-example AR and MR systems (described in detail below) can perform various functions and/or operations.

The wrist-wearable device 926, the head-wearable devices, and/or the HIPD 942 can communicatively couple via a network 925 (e.g., cellular, near field, Wi-Fi, personal area network, wireless LAN). Additionally, the wrist-wearable device 926, the head-wearable device, and/or the HIPD 942 can also communicatively couple with one or more servers 930, computers 940 (e.g., laptops, computers), mobile devices 950 (e.g., smartphones, tablets), and/or other electronic devices via the network 925 (e.g., cellular, near field, Wi-Fi, personal area network, wireless LAN). Similarly, a smart textile-based garment, when used, can also communicatively couple with the wrist-wearable device 926, the head-wearable device(s), the HIPD 942, the one or more servers 930, the computers 940, the mobile devices 950, and/or other electronic devices via the network 925 to provide inputs.

Turning to FIG. 9A, a user 902 is shown wearing the wrist-wearable device 926 and the AR device 928, and having the HIPD 942 on their desk. The wrist-wearable device 926, the AR device 928, and the HIPD 942 facilitate user interaction with an AR environment. In particular, as shown by the first AR system 900a, the wrist-wearable device 926, the AR device 928, and/or the HIPD 942 cause presentation of one or more avatars 904, digital representations of contacts 906, and virtual objects 908. As discussed below, the user 902 can interact with the one or more avatars 904, digital representations of the contacts 906, and virtual objects 908 via the wrist-wearable device 926, the AR device 928, and/or the HIPD 942. In addition, the user 902 is also able to directly view physical objects in the environment, such as a physical table 929, through transparent lens(es) and waveguide(s) of the AR device 928. Alternatively, an MR device could be used in place of the AR device 928 and a similar user experience can take place, but the user would not be directly viewing physical objects in the environment, such as the table 929, and would instead be presented with a virtual reconstruction of the table 929 produced from one or more sensors of the MR device (e.g., an outward facing camera capable of recording the surrounding environment).

The user 902 can use any of the wrist-wearable device 926, the AR device 928 (e.g., through physical inputs at the AR device and/or built-in motion tracking of a user's extremities), a smart-textile garment, an externally mounted extremity tracking device, or the HIPD 942 to provide user inputs, etc. For example, the user 902 can perform one or more hand gestures that are detected by the wrist-wearable device 926 (e.g., using one or more EMG sensors and/or IMUs built into the wrist-wearable device) and/or AR device 928 (e.g., using one or more image sensors or cameras) to provide a user input. Alternatively, or additionally, the user 902 can provide a user input via one or more touch surfaces of the wrist-wearable device 926, the AR device 928, and/or the HIPD 942, and/or voice commands captured by a microphone of the wrist-wearable device 926, the AR device 928, and/or the HIPD 942. The wrist-wearable device 926, the AR device 928, and/or the HIPD 942 include an artificially intelligent digital assistant to help the user in providing a user input (e.g., completing a sequence of operations, suggesting different operations or commands, providing reminders, confirming a command). For example, the digital assistant can be invoked through an input occurring at the AR device 928 (e.g., via an input at a temple arm of the AR device 928). In some embodiments, the user 902 can provide a user input via one or more facial gestures and/or facial expressions. For example, cameras of the wrist-wearable device 926, the AR device 928, and/or the HIPD 942 can track the user 902's eyes for navigating a user interface.

The wrist-wearable device 926, the AR device 928, and/or the HIPD 942 can operate alone or in conjunction to allow the user 902 to interact with the AR environment. In some embodiments, the HIPD 942 is configured to operate as a central hub or control center for the wrist-wearable device 926, the AR device 928, and/or another communicatively coupled device. For example, the user 902 can provide an input to interact with the AR environment at any of the wrist-wearable device 926, the AR device 928, and/or the HIPD 942, and the HIPD 942 can identify one or more back-end and front-end tasks to cause the performance of the requested interaction and distribute instructions to cause the performance of the one or more back-end and front-end tasks at the wrist-wearable device 926, the AR device 928, and/or the HIPD 942. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 942 can perform the back-end tasks and provide the wrist-wearable device 926 and/or the AR device 928 operational data corresponding to the performed back-end tasks such that the wrist-wearable device 926 and/or the AR device 928 can perform the front-end tasks. In this way, the HIPD 942, which has more computational resources and greater thermal headroom than the wrist-wearable device 926 and/or the AR device 928, performs computationally intensive tasks and reduces the computer resource utilization and/or power usage of the wrist-wearable device 926 and/or the AR device 928.

In the example shown by the first AR system 900a, the HIPD 942 identifies one or more back-end tasks and front-end tasks associated with a user request to initiate an AR video call with one or more other users (represented by the avatar 904 and the digital representation of the contact 906) and distributes instructions to cause the performance of the one or more back-end tasks and front-end tasks. In particular, the HIPD 942 performs back-end tasks for processing and/or rendering image data (and other data) associated with the AR video call and provides operational data associated with the performed back-end tasks to the AR device 928 such that the AR device 928 performs front-end tasks for presenting the AR video call (e.g., presenting the avatar 904 and the digital representation of the contact 906).

In some embodiments, the HIPD 942 can operate as a focal or anchor point for causing the presentation of information. This allows the user 902 to be generally aware of where information is presented. For example, as shown in the first AR system 900a, the avatar 904 and the digital representation of the contact 906 are presented above the HIPD 942. In particular, the HIPD 942 and the AR device 928 operate in conjunction to determine a location for presenting the avatar 904 and the digital representation of the contact 906. In some embodiments, information can be presented within a predetermined distance from the HIPD 942 (e.g., within five meters). For example, as shown in the first AR system 900a, virtual object 908 is presented on the desk some distance from the HIPD 942. Similar to the above example, the HIPD 942 and the AR device 928 can operate in conjunction to determine a location for presenting the virtual object 908. Alternatively, in some embodiments, presentation of information is not bound by the HIPD 942. More specifically, the avatar 904, the digital representation of the contact 906, and the virtual object 908 do not have to be presented within a predetermined distance of the HIPD 942. While an AR device 928 is described as working with an HIPD, an MR headset can be interacted with in the same way as the AR device 928.

User inputs provided at the wrist-wearable device 926, the AR device 928, and/or the HIPD 942 are coordinated such that the user can use any device to initiate, continue, and/or complete an operation. For example, the user 902 can provide a user input to the AR device 928 to cause the AR device 928 to present the virtual object 908 and, while the virtual object 908 is presented by the AR device 928, the user 902 can provide one or more hand gestures via the wrist-wearable device 926 to interact and/or manipulate the virtual object 908. While an AR device 928 is described as working with a wrist-wearable device 926, an MR headset can be interacted with in the same way as the AR device 928.

### Integration of Artificial Intelligence With Xr Systems

FIG. 9A illustrates an interaction in which an artificially intelligent virtual assistant can assist in requests made by a user 902. The AI virtual assistant can be used to complete open-ended requests made through natural language inputs by a user 902. For example, in FIG. 9A, the user 902 makes an audible request 944 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 9A also illustrates an example neural network 952 used in Artificial Intelligence applications. Uses of Artificial Intelligence (AI) are varied and encompass many different aspects of the devices and systems described herein. AI capabilities cover a diverse range of applications and deepen interactions between the user 902 and user devices (e.g., the AR device 928, an MR device 932, the HIPD 942, the wrist-wearable device 926). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models, and, based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 902 can interact with an AI model through natural language inputs captured by a voice sensor, text inputs, or any other input modality that accepts natural language and/or a corresponding voice sensor module. In another instance, input is provided by tracking the eye gaze of a user 902 via a gaze tracker module. Additionally, the AI model can also receive inputs beyond those supplied by a user 902. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' 0data can be retrieved completely from a single device (e.g., AR device 928) or from multiple devices that are in communication with each other (e.g., a system that includes at least two of an AR device 928, an MR device 932, the HIPD 942, the wrist-wearable device 926, etc.). The AI model can also access additional information (e.g., one or more servers 930, the computers 940, the mobile devices 950, and/or other electronic devices) via a network 925.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 928, an MR device 932, the HIPD 942, the wrist-wearable device 926) via the one or more networks. The cloud-computing platforms provide scalable computing resources, distributed computing, managed AI services, interference acceleration, pre-trained models, APIs and/or other resources to support comprehensive computations used by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 928, an MR device 932, the HIPD 942, the wrist-wearable device 926), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 942), haptic feedback can provide information to the user 902. An AI model can also use the inputs described above to determine the appropriate modality and device(s) to present content to the user (e.g., a user walking on a busy road can be presented with an audio output instead of a visual output to avoid distracting the user 902).

### Example Augmented-Reality Interaction

FIG. 9B shows the user 902 wearing the wrist-wearable device 926 and the AR device 928, and holding the HIPD 942. In the second AR system 900b, the wrist-wearable device 926, the AR device 928, and/or the HIPD 942 are used to receive and/or provide one or more messages to a contact of the user 902. In particular, the wrist-wearable device 926, the AR device 928, and/or the HIPD 942 detect and coordinate one or more user inputs to initiate a messaging application and prepare a response to a received message via the messaging application.

In some embodiments, the user 902 initiates, via a user input, an application on the wrist-wearable device 926, the AR device 928, and/or the HIPD 942 that causes the application to initiate on at least one device. For example, in the second AR system 900b, the user 902 performs a hand gesture associated with a command for initiating a messaging application (represented by messaging user interface 912); the wrist-wearable device 926 detects the hand gesture; and, based on a determination that the user 902 is wearing the AR device 928, causes the AR device 928 to present a messaging user interface 912 of the messaging application. The AR device 928 can present the messaging user interface 912 to the user 902 via its display (e.g., as shown by user 902's field of view 910). In some embodiments, the application is initiated and can be run on the device (e.g., the wrist-wearable device 926, the AR device 928, and/or the HIPD 942) that detects the user input to initiate the application, and the device provides another device operational data to cause the presentation of the messaging application. For example, the wrist-wearable device 926 can detect the user input to initiate a messaging application, initiate and run the messaging application, and provide operational data to the AR device 928 and/or the HIPD 942 to cause presentation of the messaging application. Alternatively, the application can be initiated and run at a device other than the device that detected the user input. For example, the wrist-wearable device 926 can detect the hand gesture associated with initiating the messaging application and cause the HIPD 942 to run the messaging application and coordinate the presentation of the messaging application.

Further, the user 902 can provide a user input provided at the wrist-wearable device 926, the AR device 928, and/or the HIPD 942 to continue and/or complete an operation initiated at another device. For example, after initiating the messaging application via the wrist-wearable device 926 and while the AR device 928 presents the messaging user interface 912, the user 902 can provide an input at the HIPD 942 to prepare a response (e.g., shown by the swipe gesture performed on the HIPD 942). The user 902's gestures performed on the HIPD 942 can be provided and/or displayed on another device. For example, the user 902's swipe gestures performed on the HIPD 942 are displayed on a virtual keyboard of the messaging user interface 912 displayed by the AR device 928.

In some embodiments, the wrist-wearable device 926, the AR device 928, the HIPD 942, and/or other communicatively coupled devices can present one or more notifications to the user 902. The notification can be an indication of a new message, an incoming call, an application update, a status update, etc. The user 902 can select the notification via the wrist-wearable device 926, the AR device 928, or the HIPD 942 and cause presentation of an application or operation associated with the notification on at least one device. For example, the user 902 can receive a notification that a message was received at the wrist-wearable device 926, the AR device 928, the HIPD 942, and/or other communicatively coupled device and provide a user input at the wrist-wearable device 926, the AR device 928, and/or the HIPD 942 to review the notification, and the device detecting the user input can cause an application associated with the notification to be initiated and/or presented at the wrist-wearable device 926, the AR device 928, and/or the HIPD 942.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 928 can present to the user 902 game application data and the HIPD 942 can use a controller to provide inputs to the game. Similarly, the user 902 can use the wrist-wearable device 926 to initiate a camera of the AR device 928, and the user can use the wrist-wearable device 926, the AR device 928, and/or the HIPD 942 to manipulate the image capture (e.g., zoom in or out, apply filters) and capture image data.

While an AR device 928 is shown being capable of some functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention can be directed. Some AR devices can present AR augments either monocularly or binocularly (e.g., an AR augment can be presented at just a single display associated with a single lens as opposed to presenting an AR augmented at both lenses to produce a binocular image). In some instances, an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed-Reality Interaction

Turning to FIGS. 9C-1 and 9C-2, the user 902 is shown wearing the wrist-wearable device 926 and an MR device 932 (e.g., a device capable of providing either an entirely VR experience or an MR experience that displays object(s) from a physical environment at a display of the device) and holding the HIPD 942. In the third AR system 900c, the wrist-wearable device 926, the MR device 932, and/or the HIPD 942 are used to interact within an MR environment, such as a VR game or other MR/VR application. While the MR device 932 presents a representation of a VR game (e.g., first MR game environment 920) to the user 902, the wrist-wearable device 926, the MR device 932, and/or the HIPD 942 detect and coordinate one or more user inputs to allow the user 902 to interact with the VR game.

In some embodiments, the user 902 can provide a user input via the wrist-wearable device 926, the MR device 932, and/or the HIPD 942 that causes an action in a corresponding MR environment. For example, the user 902 in the third MR system 900c (shown in FIG. 9C-1) raises the HIPD 942 to prepare for a swing in the first MR game environment 920. The MR device 932, responsive to the user 902 raising the HIPD 942, causes the MR representation of the user 922 to perform a similar action (e.g., raise a virtual object, such as a virtual sword 924). In some embodiments, each device uses respective sensor data and/or image data to detect the user input and provide an accurate representation of the user 902's motion. For example, image sensors (e.g., SLAM cameras or other cameras) of the HIPD 942 can be used to detect a position of the HIPD 942 relative to the user 902's body such that the virtual object can be positioned appropriately within the first MR game environment 920; sensor data from the wrist-wearable device 926 can be used to detect a velocity at which the user 902 raises the HIPD 942 such that the MR representation of the user 922 and the virtual sword 924 are synchronized with the user 902's movements; and image sensors of the MR device 932 can be used to represent the user 902's body, boundary conditions, or real-world objects within the first MR game environment 920.

In FIG. 9C-2, the user 902 performs a downward swing while holding the HIPD 942. The user 902's downward swing is detected by the wrist-wearable device 926, the MR device 932, and/or the HIPD 942, and a corresponding action is performed in the first MR game environment 920. In some embodiments, the data captured by each device is used to improve the user 902's experience within the MR environment. For example, sensor data of the wrist-wearable device 926 can be used to determine a speed and/or force at which the downward swing is performed and image sensors of the HIPD 942 and/or the MR device 932 can be used to determine a location of the swing and how it should be represented in the first MR game environment 920, which, in turn, can be used as inputs for the MR environment (e.g., game mechanics, which can use detected speed, force, locations, and/or aspects of the user 902's actions to classify a user's inputs (e.g., user performs a light strike, hard strike, critical strike, glancing strike, miss) or calculate an output (e.g., amount of damage)).

FIG. 9C-2 further illustrates that a portion of the physical environment is reconstructed and displayed at a display of the MR device 932 while the MR game environment 920 is being displayed. In this instance, a reconstruction of the physical environment 946 is displayed in place of a portion of the MR game environment 920 when object(s) in the physical environment are potentially in the path of the user (e.g., a collision with the user and an object in the physical environment are likely). Thus, this example MR game environment 920 includes (i) an immersive VR portion 948 (e.g., an environment that does not have a corollary counterpart in a nearby physical environment) and (ii) a reconstruction of the physical environment 946 (e.g., table 950 and cup 952). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 926, the MR device 932, and/or the HIPD 942 are described as detecting user inputs, in some embodiments, user inputs are detected at a single device (with the single device being responsible for distributing signals to the other devices for performing the user input). For example, the HIPD 942 can operate an application for generating the first MR game environment 920 and provide the MR device 932 with corresponding data for causing the presentation of the first MR game environment 920, as well as detect the user 902's movements (while holding the HIPD 942) to cause the performance of corresponding actions within the first MR game environment 920. Additionally or alternatively, in some embodiments, operational data (e.g., sensor data, image data, application data, device data, and/or other data) of one or more devices is provided to a single device (e.g., the HIPD 942) to process the operational data and cause respective devices to perform an action associated with processed operational data.

In some embodiments, the user 902 can wear a wrist-wearable device 926, wear an MR device 932, wear smart textile-based garments 938 (e.g., wearable haptic gloves), and/or hold an HIPD 942 device. In this embodiment, the wrist-wearable device 926, the MR device 932, and/or the smart textile-based garments 938 are used to interact within an MR environment (e.g., any AR or MR system described above in reference to FIGS. 9A and 9B). While the MR device 932 presents a representation of an MR game (e.g., second MR game environment 920) to the user 902, the wrist-wearable device 926, the MR device 932, and/or the smart textile-based garments 938 detect and coordinate one or more user inputs to allow the user 902 to interact with the MR environment.

In some embodiments, the user 902 can provide a user input via the wrist-wearable device 926, an HIPD 942, the MR device 932, and/or the smart textile-based garments 938 that causes an action in a corresponding MR environment. In some embodiments, each device uses respective sensor data and/or image data to detect the user input and provide an accurate representation of the user 902's motion. While four different input devices are shown (e.g., a wrist-wearable device 926, an MR device 932, an HIPD 942, and a smart textile-based garment 938), each one of these input devices completely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 938), sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 938 can be used in conjunction with an MR device and/or an HIPD 942.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that some types of the components described may be more suitable for a particular set of devices, and less suitable for a different set of devices. But subsequent references to the components defined here are to be considered to be encompassed by the definitions provided.

In some embodiments, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 9A through 9C-2 provided above are intended to augment the description provided in Appendix A included herein. While terms in Appendix A may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements are not limited by these terms. These terms are used to distinguish one element from another.

The terminology used herein is for the purpose of describing particular embodiments and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when,” “upon,” “in response to determining,” “in accordance with a determination,” or “in response to detecting,” that a stated condition precedent is true, depending on the context. Similarly, the phrase “if it is determined [that a stated condition precedent is true],” “if [a stated condition precedent is true],” or “when [a stated condition precedent is true]” can be construed to mean “upon determining,” “in response to determining,” “in accordance with a determination,” “upon detecting,” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer-readable storage medium storing instructions that, when executed by control circuitry of an electronic device having a display comprising a pixel array and a plurality of compute tiles stacked with the pixel array, cause the control circuitry to perform operations, comprising:
receiving image data corresponding to a frame to be displayed;
dividing the image data into a set of tile data corresponding to different portions of the pixel array; and
concurrently processing, via the plurality of compute tiles, the set of tile data, including for each tile data in the set of tile data:
processing the tile data to generate processed tile data; and
driving, based on the processed tile data, a corresponding subset of the pixel array.

2. The non-transitory computer-readable storage medium of claim 1, wherein processing the tile data to generate the processed tile data comprises:
generating gamma-corrected tile data by applying a gamma correction to the tile data;
generating scaled tile data by resizing the gamma-corrected tile data; and
generating the processed tile data by converting the scaled tile data to a pulse-width modulation (PWM) signal.

3. The non-transitory computer-readable storage medium of claim 1, wherein driving, based on the processed tile data, the corresponding subset of the pixel array includes:
storing the processed tile data in a respective compute tile, of the plurality of compute tiles, as a respective frame buffer; and
concurrently loading the respective frame buffer from the respective compute tile for driving the corresponding subset of the pixel array.

4. The non-transitory computer-readable storage medium of claim 1, wherein a respective compute tile, of the plurality of compute tiles, is spatially proximate to the corresponding subset of the pixel array and configured to drive the corresponding subset of the pixel array through a corresponding analog driver.

5. The non-transitory computer-readable storage medium of claim 1, wherein each of the plurality of compute tiles corresponds to a distinct subset of the pixel array.

6. The non-transitory computer-readable storage medium of claim 1, wherein the display further includes an analog driver, and wherein:
the analog driver is vertically stacked over the plurality of compute tiles; and
the pixel array is vertically stacked over the analog driver.

7. The non-transitory computer-readable storage medium of claim 6, wherein:
the plurality of compute tiles are electrically coupled to the analog driver via through-silicon vias (TSVs) and configured to drive the analog driver; and
the analog driver is heterogeneously integrated to the plurality of compute tiles through hybrid bonding and configured to drive the pixel array.

8. A method of displaying images at an electronic device having a display comprising a pixel array and a plurality of compute tiles stacked with the pixel array, the method comprising:
receiving image data corresponding to a frame to be displayed;
dividing the image data into a set of tile data corresponding to different portions of the pixel array; and
concurrently processing, via the plurality of compute tiles, the set of tile data, including for each tile data in the set of tile data:
processing the tile data to generate processed tile data; and
driving, based on the processed tile data, a corresponding subset of the pixel array.

9. The method of claim 8, wherein processing the tile data to generate the processed tile data comprises:
generating gamma-corrected tile data by applying a gamma correction to the tile data;
generating scaled tile data by resizing the gamma-corrected tile data; and
generating the processed tile data by converting the scaled tile data to a pulse-width modulation (PWM) signal.

10. The method of claim 8, wherein driving, based on the processed tile data, the corresponding subset of the pixel array includes:
storing the processed tile data in a respective compute tile, of the plurality of compute tiles, as a respective frame buffer; and
concurrently loading the respective frame buffer from the respective compute tile for driving the corresponding subset of the pixel array.

11. The method of claim 8, wherein each respective compute tile of the plurality of compute tiles is spatially proximate to the corresponding subset of the pixel array and configured to drive the corresponding subset of the pixel array through a corresponding analog driver.

12. The method of claim 8, wherein each of the plurality of compute tiles corresponds to a distinct subset of the pixel array.

13. The method of claim 8, wherein the display further includes an analog driver, and wherein:
the analog driver is vertically stacked over the plurality of compute tiles; and
the pixel array is vertically stacked over the analog driver.

14. The method of claim 13, wherein:
the plurality of compute tiles are electrically coupled to the analog driver via through-silicon vias (TSVs) and configured to drive the analog driver; and
the analog driver is heterogeneously integrated to the plurality of compute tiles through hybrid bonding and configured to drive the pixel array.

15. An electronic device comprising:
a display comprising a pixel array and a plurality of compute tiles stacked with the pixel array; and
control circuitry configured to:
receive image data corresponding to a frame to be displayed;
divide the image data into a set of tile data corresponding to different portions of the pixel array; and
concurrently process, via the plurality of compute tiles, the set of tile data, including for each tile data in the set of tile data:
process the tile data to generate processed tile data; and
drive, based on the processed tile data, a corresponding subset of the pixel array.

16. The electronic device of claim 15, wherein the control circuitry is further configured to process the tile data to generate the processed tile data by:
generating gamma-corrected tile data by applying a gamma correction to the tile data;
generating scaled tile data by resizing the gamma-corrected tile data; and
generating the processed tile data by converting the scaled tile data to a pulse-width modulation (PWM) signal.

17. The electronic device of claim 15, wherein the control circuitry is further configured to drive, based on the processed tile data, the corresponding subset of the pixel array by:
storing the processed tile data in a respective compute tile of the plurality of compute tiles as a respective frame buffer; and
concurrently loading the respective frame buffer from the respective compute tile for driving the corresponding subset of the pixel array.

18. The electronic device of claim 15, wherein each respective compute tile of the plurality of compute tiles is spatially proximate to the corresponding subset of the pixel array and configured to drive the corresponding subset of the pixel array through a corresponding analog driver.

19. The electronic device of claim 15, wherein each of the plurality of compute tiles corresponds to a distinct subset of the pixel array.

20. The electronic device of claim 15, wherein the display further includes an analog driver, and wherein:
the analog driver is vertically stacked over the plurality of compute tiles; and
the pixel array is vertically stacked over the analog driver.
